(19) United States
(12) Patent Application Publication
(10) Pub. No.: US 2006/0285548 A1
(43) Pub. Date: Dec. 21, 2006

(54) Matching process

(76) Inventors: Alan Michael Hill, Suffolk (GB); Albert Rafel, Suffolk (GB); Terrence G. Hoogkinson, Suffolk (GB)

Correspondence Address: NIXON & VANDERHYE, PC, 901 NORTH GLEBE ROAD, 11TH FLOOR, ARLINGTON, VA, 22203, US

(21) Appl. No.: 10/573,154

(22) PCT Filed: Sep. 29, 2004
(86) PCT No.: PCT/GB04/04159

§ 371 Date: Mar. 23, 2006

(30) Foreign Application Priority Data
Sep. 29, 2003 (GB) 0322765.9
Dec. 11, 2003 (GB) 0328889.1

(51) Int. Cl. H04L 12/56

(52) U.S. Cl. 370/416; 370/418

(57) ABSTRACT

A matching method for a multi-stage switch arrangement having a plurality of logically associated inputs and a plurality of outputs, wherein the matching method comprises the steps of: for each logical association of inputs, aggregating service requests from every one of the inputs which form said logical association; resolving contention for said aggregated service requests between all of the logical associations to the outputs of the switch arrangement; and repeating the above steps in the matching method within each logical association for a subset of the inputs forming each said logical association until contention is resolved between the individual inputs of the switch arrangement and the outputs of the switch arrangement.

This invention relates to a matching process for use in a contention resolution scheme for a multi-stage switch arrangement particularly but not exclusively for a cell, packet or circuit switch or network. In particular, but not exclusively, the invention relates to a scalable hierarchical matching algorithm, particularly but not exclusively suitable for matching asymmetric request matrices.

The term “matching” refers to the matching of requests for transmitting input-queued traffic to available outputs when scheduling cells or packets for transmission across a switch. The term “input-queued traffic” refers to traffic buffered at the input ports of a switch prior to switching across the switch fabric. An overall scheduling operation comprises the matching process described herein and a time-slot assignment process which determines actual channel availability for transmission across the switch fabric. One example of a time-slot assignment process is described by the inventors in their United Kingdom Patent Application No. GB-A-0322763.4, the contents of which are hereby incorporated into the description by reference.

The term switch is used herein to refer to switches and/or routers and/or networks which forward data towards their destination, such as are used in communication networks, for example, the Internet. The present invention also relates to the matching of circuit-switched service requests, such as connections and information rates, for switching across a switch fabric. This description is written in terms of cell and packet switches, but the principles also apply to circuit switches (for example, in the context that the matching process seeks to grant service requests without contention, and the services requests can equivalently be requests for bandwidth etc. in a circuit switch).

As communication networks, particularly the internet, evolve, faster and more efficient switches are needed, for example, switches capable of exceeding Terabit per second throughputs. There is therefore a demand for faster and more efficient high-throughput schedulers to schedule traffic through such switches, and therefore a demand to generate computationally faster and more efficient scheduling algorithms.

Packet switching involves the switching of data in packets through a data network. An arriving packet could be variable or fixed length, unicast or multicast. A packet is multicast if it has more than one destination port. Variable length and/or multicast packets can be transferred to fixed-length unicast packets by methods well known in the art, and the term “cell” is used to refer to a fixed-length unicast data packet. A cell consists of the header and payload, and each cell has a unique identifier, a sequence number and the destination address (the destination output port number) of the cell which is encapsulated in the header.

Input Queued Switching Schemes

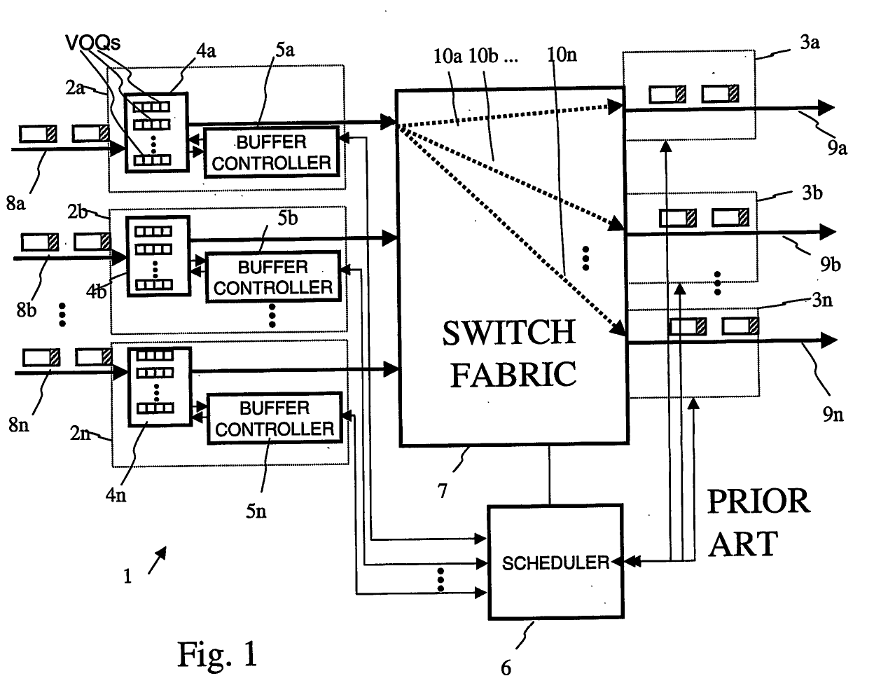

FIG. 1 of the accompanying drawings shows a general model of an N×N switch where of the N input and N output ports, only three input and three output ports are shown for convenience and clarity. Accordingly in FIG. 1, switch 1 is shown having input ports 2a, 2b, . . . , 2n and output ports 3a,3b, . . . , 3n. Each input port 2a, 2b, . . , 2n is provided with one (or more) input buffers 4a,4b, . . . , 4n respectively, the buffer(s) for each port being controlled by one or more buffer controllers 5a,5b, . . . , 5n respectively. In a virtual output queued input queued switch, a number of virtual output queues (VOQ) are provided: each input port having a VOQ for each destination port (i.e., each input port in the N×N switch has N VOQs) and pointers are used to point to the addresses of the cells in each VOQ. VOQs are described in more detail later herein below.

A scheduler 6 is used to schedule the transmission of the cells arriving along the input links 8a,8b, . . . , 8n to their destination links 9a, 9b, . . . , 9n. The scheduler 6 determines which cells from which VOQs traverse the switch fabric 7 during a switch cycle. The function of the scheduler can be distributed between the input and output ports, such that each input and output port has an arbiter associated with it, either physically or logically. Generally, a scheduler operates to switch one cell per timeslot, i.e., one cell is switched per period of time for a cell to be transmitted across the switch fabric 7. However, frame-based schedulers are known in the art in which a plurality of cells are switched over a plurality of timeslots. The operation of the switch is then synchronised over a plurality of fixed-size timeslots, which constitute a frame.

In FIG. 1, the switching fabric 7 comprises a suitable interconnecting network in the form of single-stage or multiple-stage space and/or wavelength switches. Some or all of the wavelength switches can be implemented as wavelength-switched networks. FIG. 1 for clarity only shows the possible internal input-output links 10a,10b, . . . , 10n for input port 2a, but each input port 2a,2b, . . . , 2n will have possible internal input-output links connected through the switch fabric 7 towards the appropriate destination output ports 3a,3b, . . . , 3n. Each internal input-output link within the switching fabric 7 is assumed to be capable of transmitting data at a speed of one cell per timeslot. It is not necessary for an input link 8a,8b, . . . , 8n (each of which connects to their respective input port 2a,2b, . . . , 2n) to the switch to operate at the same speed as an internal input-output link (e.g., input-output link 10a,10b, . . . , 10n) within the switch fabric 7.

During each timeslot the interconnecting network of the switch fabric 7 is capable of being configured by the scheduler to simultaneously set up a set of transmission paths between any pair of input ports 2a,2b, . . . , 2n and output ports 3a,3b, . . . , 3n provided no more than a predetermined upper limit of cells are transmitted by an input port 2a,2b, . . . , 2n or received by an output port 3a,3b, . . . , 3n during each frame.

If the packet switch 1 is to process variable sized packets, or non-unicast packets, the appropriate conversion steps into fixed sized packets (or cells) is assumed to have already occurred and thus these components are not shown in FIG. 1. In FIG. 1, each input link 2a,2b, . . . , 2n provides fixed sized packets (i.e. cells) to cell input buffer 4a,4b, . . . , 4n and buffer controllers 5a,5b, . . . , 5n respectively for header translation, addressing, and management functions which are performed on the incoming cells. The scheduler 6 processes the fixed-sized cells so that the switch fabric 7 operates in a synchronous manner.

The role of the scheduler 6 thus comprises matching each cell residing in an input buffer to its destination output port. Thus the scheduler 6 can be considered to be repeatedly solving a bipartite matching problem for each timeslot, in the manner described by Anderson et al, “High-speed switch scheduling for local-area-networks”, ACM Transactions on Computer Systems, vol. 11, no. 4, pp 319-352. By providing an appropriate match, e.g. matching a maximum number of input ports to output ports, or matching a maximum weighted number of input ports to output ports, in each switch cycle, the scheduler 6 is considered as treating the queued traffic in a useful and fair manner, depending on the nature of the traffic matrix.

In general, fixed-size packets (cells) are assumed to be switched in the switch fabric 7 to support high speed operation of the switch 1. As was mentioned above, if variable length packets are to be supported in the network, such packets are segmented and/or padded into fixed sized cells upon arrival, switched through the fabric of the switch, and reassembled into packets before departure.

Output contention can arise when cells destined for the same output port arrive simultaneously at the switch 1 at more than one input port. To suppress cell losses, such cells are buffered by the switch 1 until they can be transferred to their destination output ports. The operation of the matching algorithm can potentially cause input contention, where more than one cell could be scheduled for transmission across the switch fabric from the same input port This must be avoided by the matching algorithm. Whilst switch 1 supports a virtual output queuing (VOQ) scheme for the input queuing (IQ), a number of alternative queuing strategies are also known in the art, output queuing (OQ), shared queuing (SQ), and combined input-output queuing (CIOQ).

In a conventional input queued switch, basic input queuing (IQ) avoids using high-bandwidth buffers by providing a buffer for each input port for incoming packets. With this queuing scheme, the bandwidth demand of each input buffer is reduced to at least one write operation and one read operation per time slot. With a properly designed scheduling algorithm, a set of input-output contention free cells is selected from the buffered cells for transmission to their destination output ports, from time slot to time slot. When the overall scheduling operation is applied to a number of timeslots simultaneously in a frame of timeslots, scheduling comprises two sub-processes, matching and timeslot assignment. These processes will be described in more detail later herein below.

Whilst output queued (OQ) switches and shared queue (SQ) switches can generally achieve better performance than input queued switches and combined input-output queued switches, this is only so for a finite size of N×N switch. As the number of input and output ports of the switch increases, the bandwidth demand of the OQ or SQ buffer grows linearly as the aggregated input-output link rate increases. Accordingly, it is known in the art that OQ and SQ switches generally do not scale very well. As the switch architecture of an input queued (IQ) switch with FIFO queuing (and similarly a Combined Input-Output Queued (CIOQ) switch) is much simpler than that of OQ and SQ switches, IQ and CIOQ switches generally scale better than OQ and SQ switches as each input buffer maintains a single FIFO for all incoming cells. However, despite the simplicity in the switch architecture of an IQ switch with FIFO queuing, the maximum throughput is relatively low for uncorrelated (Bernoulli) traffic with destination outputs distributed uniformly (for example around 50%-60% or so), and the throughput is worse for correlated (on/off bursty) traffic. This is a result of the HOL blocking problem, in which a cell queuing behind the HOL cell of a FIFO cannot participate in scheduling, even if both its residing input and destination output are idle.

By supporting Virtual Output Queuing (VOQ) in the input ports of an IQ switch, HOL blocking can be removed. The Virtual Output Queue (VOQ) scheme (also known as the multiple input queuing scheme) is described in “The iSLIP Scheduling Algorithm for Input-Queued Switches” by N. McKeown, IEEE/ACM Trans. Networking, Vol. 7, No. 2, pp. 188-200 (April 1999), and U.S. Pat. No. 5,500,858, the contents of which are hereby incorporated by reference).

Conventionally, in an input-buffered VOQ switch, a fixed-size packet (or cell) is sent from any input to any output, provided that, in a given timeslot, no more than one cell is sent from the same input, and no more than one cell is received by the same output. Each input port has N VOQs, one for each of N output ports. The HOL cell in each VOQ can be selected for transmission across the switch in each timeslot. Accordingly, in each timeslot, a scheduler has to determine one set of matching, i.e., for each of the output ports, the scheduler has to match one of the corresponding VOQs with the output port.

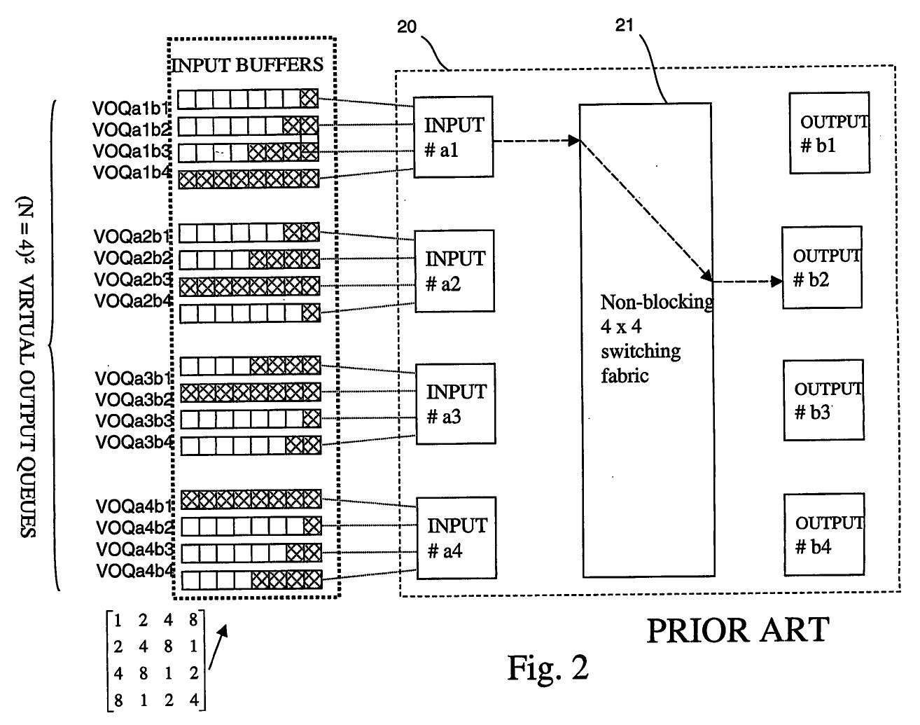

FIG. 2 of the accompanying drawing shows schematically a 4×4 VOQ IQ switch 20. Switch 20 has four input ports #a1, #a2, #a3, and #a4 and four output ports #b1, #b2, #b3, and #b4 which are capable of being interconnected by an Internal switch fabric 21. Each input port #a1, #a2, #a3, and #a4 has four VOQs, one VOQ for each of the destination output ports #b1, #b2, #b3, and #b4. In FIG. 2, the VOQs are denoted VOQ#ai#bj where i, j ranges from 1 to 4 respectively.

It is known in the art that the implementation of a VOQ scheme can enable up to 100% throughput to be achieved. Scheduling algorithms such as maximum weight matching algorithms have a high level of complexity, e.g. the number of calculations to be performed per single time-slot matching is O(N³). Currently, the amount of time it would take to perform such an algorithm to calculate the matching is impractical under high-speed environments where the duration of a time slot (the time taken to run a switching cycle i.e., to transport a cell from an input port to its destination port across the switch fabric) is very small.

Other scheduling schemes known in the art include a three-stage switch scheduling scenario in which a large packet switch is decomposed into a number of smaller switches having fewer ports (see Joseph Y Hui in “Switching and Traffic Theory for Integrated Broadband Networks”, Kluwer Academic Publishers, 1990, Chapt. 5, and J S Turner, “WDM Burst Switching for Petabit Data Networks”, OFC 2000 presentation). However, in these known schemes each switch has its own buffering which requires scheduling to be performed independently for each switch. No scheduling occurs between the switches, which leads to at least two limitations. Firstly, heuristic rules are required (e.g. load spreading between switches) to enable a reasonable switch performance to be maintained. Secondly, packets may arrive at their destination out of sequence.

Contention Resolution in an Input Queued Virtual Output Queued Switch

Consider the N×N switch shown in FIG. 1. In FIG. 1, the switch 1 has N input queues in each input port Accordingly, there are N² VOQs in total. However, switch 1 has only N output ports to transfer at most N cells to in a given timeslot. Thus contention occurs amongst the N² VOQs.

Several methods are known in the art which seek to resolve this contention issue. One known technique to reduce the computing time complexity is to use a heuristic maximal-sized matching algorithm such as the iSLIP scheduling algorithm by N. McKeown. Like many matching algorithms, iSLIP comprises 3 phases known as the request, grant, and accept phases. In the request phase, each of the N² input queues sends a request to the output ports. In the grant phase, each of the output ports grants one request among its own receiving requests using a suitable selection operation and notifies the result of grant to each of the input ports. An input port may receive several grants from each output port at the same time so that in the accept phase each of the input ports accepts one grant amongst its own receiving grants using a suitable selection process. Several request-grant-accept cycles are iteratively performed.

With such a three-phase matching approach, a problem which needs to be addressed to optimise the matching process is how to ensure that the selection processes fairly and quickly select and grant one request from a plurality of requests which could be granted (and equivalently accept one grant from a plurality of grants which could be accepted). In iSLIP, this selection process is achieved using a particular set of pointer rules. iSLIP can be faster than alternative schemes which use random selection. Unfortunately, in the iSLIP algorithm, as the number of input ports and output ports increases, the number of requests and grants which must be selected between in the grant and accept phases within one time slot increases. Although the iSLIP algorithm has less computing complexity than a maximum matching algorithm it has a limitation: iSLIP requires the maximal matching to be completed within one timeslot. Again, as the switch size increases or if a switch has very high port speeds (either because the matching time itself increases beyond the time for one time slot, or because the timeslot itself has a shorter duration) iSLIP is no longer suitable.

Several other matching schemes have been devised in the art which seek to provide greater scalability and so support faster switch cycles. For example, pipeline-based scheduling algorithms such as the Round-Robin Greedy Scheduling (RRGS) allows each input to perform only one round-robin arbitration within a given time slot to select one VOQ. For a switch with N inputs, N input round-robin operations (to select a cell to be transmitted at a given time slot T) are allocated to the different previous N time slots {T−N, T−(N+1), . . . , T−1} in a simple cyclic manner to avoid output contention. A drawback of this scheme is when traffic is not balanced across the input of the switch, some inputs can unfairly send more cells than others. Whilst other schemes are known in the art to guarantee pre-reserved bandwidth, for example, the weighted RRGS scheme, this has a drawback in that it does not guarantee fairness for best-effort traffic and a further draw back in that as every even number of timeslot cycles an idle timeslot is produced resulting in the switch capacity not being fully used.

Overview of Frame-Based Scheduling

As was discussed briefly in the introduction, the overall scheduling operation comprises two sub-processes, a matching process and a timeslot assignment process. A similar division exists where a frame-based scheduling approach is implemented.

The frame based approach comprises two steps for each frame. The first step involves a matching process in which a number of cells queued at the inputs are accepted for transmission to outputs in a non-contentious manner. The second step involves a time-slot assignment process in which the successfully matched cells are scheduled for transmission in the different time slots of the frame. This time-slot assignment step can be considered to be equivalent to scheduling a set of non-conflicting requests in a time-frame, which can be performed using known path-searching algorithms such as those used to route circuits in a Clos interconnection network, for example, see WO01/67783 “Switching Control” and also WO01/67803 “Frame Based Algorithms for Switch Control”, and WO01/67802 “Packet Switching”, all three of which are hereby incorporated by reference.

At the beginning of a frame, the total number of packet requests from each input port to each output port as a pair is collected into an N×N Request Matrix R (the request phase of the process). Each element r(i,j) of this matrix is an integer showing the total amount of stored packets in the VOQ between input port i and output port j.

The matching process populates a symmetric N×N Accepted-Requests matrix A. Each element a(i,j) of A represents the total number of accepted switching requests from the VOQ between input port i and output port j, i.e., requests that have been accepted to be switched during the following time period (frame) available for transferring one or more cells between an input port and an output port using one or more timeslots. Each accepted request a(i,j) of A is constrained by the overall capacity of the switch input and output ports “F”, i.e., the sum of elements in each row and each column must not exceed the frame size F; i.e. the number of time slots or cells in the frame. Various matching algorithms are known in the art to try to optimise the use of the available switch capacity. All of these matching algorithms seek, in each time period consisting of one or more time slots, to determine a non-conflicting match between the input ports and the output ports of a switch fabric of an N×N symmetric request matrix.

For example, where F=1 (and for unicast traffic) a matching process will seek to link each input port to at most one output port and each output port is linked to at most one input port. A complete matching of the input ports to the output ports in one timeslot is then equivalent to determining the appropriate permutation of the input ports. However, as a complete matching cannot always be achieved, maximal matching algorithms seek to optimise the selection of which cells should be transmitted from input to output per timeslot. This optimisation depends on a number of factors selected according to the particular embodiment of the matching algorithm implemented and can depend, for example, on the length of queue and/or how long the cell at the head of each queue has been queued for.

Frame-based matching where F≧1 has already been described in the art, for example, in “Frame-based matching algorithms for input-queued switches” by Andrea Bianco, Mirko Franceschinis, Stefano Ghisolfi, Alan Michael Hill, Emilio Leonardi, Fablo Neri, Rod Webb, HPSR 2002, Workshop on High Performance Switching and Routing, Kobe, Japan, 26-29 May 2002, the text of which is incorporated herein by reference. Bianco et al describe a frame-based switch contention resolution scheme which can be considered to comprise two-steps for each frame (a frame being considered to be a set of one or more time-slots).

Consider a frame whose length is F (i.e., whose transmission could occupy F consecutive timeslots). A set of cells selected to be transmitted in the timeslots belonging to the next frame is selected at the end of the current frame, i.e., switch control occurs on a multi-time-slot basis at the edge of each frame boundary. The set of cells selected for transmission is termed the F-match, and this needs to always comply with the joint criteria that i) the total number of selected cells from each input port cannot be larger than F and ii) the total number of selected cells which are to be transmitted to each output port cannot exceed F. Equivalently, if a_{i,j} is the number of accepted cells from input i to output j, the constraints are:

$$\begin{matrix}{\sum }_{i} {a}_{i , j} \leq \begin{matrix}F & ∀ & j\end{matrix} \\ and & Eqn . 1 \\ {\sum }_{j} {a}_{i , j} \leq \begin{matrix}F & ∀ & i .\end{matrix} & Eqn . 2\end{matrix}$$

The selection of the cells forming the set to be transmitted in the next frame is made using an F-matching algorithm (and where F=1, the F-matching is equivalent to a conventional time-slot by time-slot approach). Once the F-match has been obtained, cell transmissions need to be assigned to different timeslots of the frame, i.e., a set of at least F switch permutations capable of transferring all cells belonging to the F-match in a non-conflicting manner.

The frame-based matching scheme Bianco et al describe is implemented using a request/grant/accept scheme in a manner similar to iSLIP. iSLIP utilises a rotating priority scheme in which the selection of requests to be granted (at outputs) and of grants to be accepted (at inputs) is implemented using two sets of N pointers, one for each input and one for each output. An output (input) pointer points to the input (output) port to which highest priority is given in issuing grants (acceptances). Accordingly, grants and acceptances are given to the first busy queue in a cyclic order starting from the current pointer position. Input and output pointers are up-dated after each matching to the first input (output) following the one which has been accepted.

Bianco et al also describe a “No Over Booking” (NOB) matching algorithm consisting of a generalisation of the known iSLIP algorithm by McKeown et al, but one or more iterations (i.e., a generalisation of 1-SLIP) and associated pointer update rules. The NOB algorithm output booking and input booking steps are described in detail in Bianco et al, and are incorporated herein by reference. Briefly, the NOB algorithm steps through an output booking phase followed by an input booking phase, similarly to iSLIP. In the output booking phase, each virtual output queue (VOQ) requests a number of time-slots in the appropriate output frame, and as a reply each output port issues up to F grants distributed amongst the N VOQs destined for that output. The total number of requests is represented by a request matrix R, whose elements r_{i,j} represent the total number of time slots requested by input port i for output port j.

In general the length q_{i,j} of each VOQ (i.e. the number of cells queued) can be greater than the frame length F. The number of actual requests made by each VOQ from the request matrix R is up to q_{i,j} when q_{i,j}<F but if q_{i,j}≧F then up to F (as no more than F time slots can be requested at any one time). The request matrix R is distinguished from the normalisation phase matrix to be discussed below which uses as its input “requests” the actual queue lengths, but which does not reduce the number of requests in each VOQ to the frame length F prior to the first stage of matching.

During the output booking phase, each output port operates simultaneously, hence output ports operate independently, so that there is no guarantee that the total number of grants received by VOQs at one input port will not exceed the capacity of the input frame. To remedy this, each input port accepts up to F of the grants received at that port. Each acceptance received by a VOQ at one input port gives that port the right to transmit one cell in the next frame.

The NOB frame matching algorithm Bianco et al describe is in some sense therefore a hybrid between a maximum weight matching (MWM) (which assigns a weight to the cells at the head of each VOQ, and which optimises the cumulative weight of cells which are successfully matched) and a maximum size matching (MSM) (which addresses optimising on the basis of the overall number of cells which are successfully matched being a maximum). In each phase, the final steps in the above algorithms begin on an initial VOQ which is indicated by a pointer. Accordingly, each output port maintains a pointer showing which input port should be given priority for its additional grants in the final output booking step, and each input port keeps a pointer showing which output port has priority in its final input booking step. Several schemes are known in the art for updating the pointers so that a level of fairness is maintained.

Prior art such as U.S. Pat. No. 6,487,213 entitled “Methods and Apparatus for Fairly Arbitrating Contention for an Output Port” by Chao describe hierarchical arbitration methods in which requests are aggregated together, but arbitration is performed independently for different output ports. Matching is not performed globally between all input and output ports to solve contention across the entire switch fabric, nor does Chao address the issue of resolving contention in an input-switch, as Chao addresses the issue where both input and output queuing are provided.

Consider when the original request matrix R₀ is transformed to a normalised request matrix Rₙₒᵣₘ by transformation factor d. The original request matrix R₀ could be, for example, the matrix of VOQ queue lengths (i.e. numbers of requests or cells queued in each VOQ) or a measure of the requested traffic rates. An example of a transformation factor d is described later. Rᵣ=R₀−Rₙₒᵣₘ is the request matrix of remaining requests given by the original request matrix R₀ and Rₙₒᵣₘ is the partially populated Accepted-Requests matrix A from the first stage of the matching. Rᵣ is used to fill up as much of the remaining capacity of the frame as possible, by running another matching algorithm (which could be the same as the first or different) in a second stage to populate a second accepted requests matrix A₂ derived from the matrix of remaining requests Rᵣ. The final matrix of accepted requests A=Rₙₒᵣₘ+A₂, i.e., A is just the sum of the two matrices found during the two stages. Consider the following example request matrix

$${R}_{O} = ( \begin{matrix}3 & 4 & 2 & 0 \\ 5 & 0 & 1 & 0 \\ 8 & 5 & 1 & 3 \\ 2 & 0 & 2 & 6\end{matrix} ) \qquad Eqn . 3$$

This is transformed by a transformation factor d=F/max (F,mval), where F=8 and mval is defined to be the maximum sum of any one column or row in R_{O}, i.e.,

$$mval = max ( {\sum }_{i = 1}^{4} {r}_{i , j} 1 \leq j \leq 4 , {\sum }_{j = 1}^{4} {r}_{i , j} 1 \leq i \leq 4 ) \qquad Eqn . 4$$

Here d=8/18 and thus R₀=└4R/9┘, where the elements of R₀ are the integer parts of the resulting numbers. For this example, then

$${R}_{norm} = ( \begin{matrix}1 & 1 & 0 & 0 \\ 2 & 0 & 0 & 0 \\ 3 & 2 & 0 & 1 \\ 0 & 0 & 0 & 2\end{matrix} ) \qquad Eqn . 5$$

The remaining request matrix=

$${R}_{r} = {R}_{0} - {R}_{norm} = ( \begin{matrix}2 & 3 & 2 & 0 \\ 3 & 0 & 1 & 0 \\ 5 & 3 & 1 & 2 \\ 2 & 0 & 2 & 4\end{matrix} ) \qquad Eqn . 6$$

A second matching procedure is then performed on the remaining request matrix Rᵣ which produces another Accepted Requests matrix A₂. The total Accepted Requests Matrix A per frame is then given by the sum of Rₙₒᵣₘ and A₂, i.e., A=Rₙₒᵣₘ+A₂.

Therefore the operation of an existing, example single-level matching algorithm known in the art can be summarised as follows.

Normalisation Stage

First the elements in the request matrix are transformed by normalising them according to the highest queue value and the total number of timeslots available in a frame, so that in the normalisation phase:
[r(i,j)] [symbol] [rₙₒᵣₘ(i,j)], rᵣ(i,j)] Eqn. 7

“No Overbooking” Stage

This comprises an output booking phase followed by an input booking phase. In the output booking phase, a granted-request matrix is formed from the matrix of remaining requests, i.e., in the output port booking phase the grants are derived as follows:

$$[ {r}_{r} ( i , j ) ] ⇒ [ g ( i , j ) ] ; \\ {\sum }_{i} g ( i , j ) \leq F - [ {\sum }_{i} {Q}_{norm} ( i , j ) ] , \qquad Eqn . 8$$

where Qₙₒᵣₘ is the number of normalised requests queued for a particular output port. In the input booking phase, an accepted grant matrix is generated from the matrix of granted requests, i.e., the accepted grants populate this matrix according to:

$$[ g ( i , j ) ] ⇒ [ a ( i , j ) ] ; \\ {\sum }_{j} a ( i , j ) \leq F \qquad Eqn . 9$$

Time Slot Assignment

The second process of the scheduling algorithm is the Time Slot Assignment. It attempts to compute the set of switch (or network) configurations for each time slot, such that the matrix of accepted requests can be transferred from the input ports to the output ports across the switch without blocking any packet, i.e., to ensure there is a free time slot available for each packet from its input port to its desired output port. This is not always possible, depending on the Time Slot Assignment algorithm and the number of time slots (switch permutations) available. Some or even all of this set of switch permutations may be the same. As an example, consider the request acceptance matrix

$$A = [ a ( i , j ) , 1 \leq ( i , j ) \leq 4 ] = [ \begin{matrix}2 & 4 & 2 & 0 \\ 3 & 1 & 3 & 1 \\ 2 & 3 & 1 & 2 \\ 1 & 0 & 2 & 5\end{matrix} ] \qquad Eqn . 10$$

A possible set of 8 switch permutations to send these numbers of cells or packets from input ports to the output ports (elements in the table) across the switch is shown in the following table

| | Time slot [symbol] | | | | | | | |
|---|---|---|---|---|---|---|---|---|
| Input Port [symbol] | 1 | 2 | 3 | 4 | 5 | 6 | 7 | 8 |
| 1 | 1 | 1 | 2 | 2 | 2 | 2 | 3 | 3 |
| 2 | 3 | 4 | 1 | 3 | 1 | 3 | 2 | 1 |
| 3 | 2 | 2 | 4 | 4 | 3 | 1 | 1 | 2 |
| 4 | 4 | 3 | 3 | 1 | 4 | 4 | 4 | 4 |

If we call this set of permutations Pₙ, where n is the time slot within the frame (1≦n≦F), then it would correspond to the following sequence of permutation matrices

$${P}_{1} [ \begin{matrix}1 & 0 & 0 & 0 \\ 0 & 0 & 1 & 0 \\ 0 & 1 & {0}^{′} & 0 \\ 0 & 0 & 0 & 1\end{matrix} ] {P}_{2} = [ \begin{matrix}1 & 0 & 0 & 0 \\ 0 & 0 & 0 & 1 \\ 0 & 1 & 0 & 0 \\ 0 & 0 & 1 & 0\end{matrix} ] … , {P}_{8} = [ \begin{matrix}0 & 0 & 1 & 0 \\ 1 & 0 & 0 & 0 \\ 0 & 1 & 0 & 0 \\ 0 & 0 & 0 & 1\end{matrix} ] \qquad Eqn . 11$$

Several algorithms are known in the art suitable for implementing time slot assignment, with different blocking characteristics, dependent also on the number of time slots (switch permutations) available.

Referring now to FIG. 2 of the accompanying drawings, an input queued cell (or packet) switch arrangement is shown. In FIG. 2, each of the four input ports #a1 . . . #a4 has four first-in-first-out virtual output queues (VOQs), designated as VOQa1b1 . . . VOQa4b4. Each of the VOQs associated with the same input port stores cells destined for a different output port, the total length of the queue from input port i to output port j (the number of cells to be transmitted in the next time frame) being indicated by q_{i,j} where i, j=1, 2, . . . , N. Cells which queue up in the VOQs generate requests which can be presented by a queue matrix as shown below (and in FIG. 2). In general, the number of cells queued in a VOQ can exceed the frame size F.

As an example of a conventional single-level matching an example queue matrix [Q(i,j)] such as is shown in FIG. 2, for a 4×4 switch having a frame duration F of F=4 time slots is matched below. The VOQ lengths, i.e. the number of cells or packets waiting in each VOQ, are assumed to have a “powers of two” distribution, i.e.

$$[ Q ( i , j ) ] = [ \begin{matrix}1 & 2 & 4 & 8 \\ 2 & 4 & 8 & 1 \\ 4 & 8 & 1 & 2 \\ 8 & 1 & 2 & 4\end{matrix} ] \qquad Eqn . 12$$

A conventional single-level frame-based matching process in which a number of stages are present in the matching process will now be described.

Single-Level Matching Normalisation Stage

The normalisation algorithm first finds the row (input port) or column (output port) with the largest sum of requests (or queue lengths), maxval. Every request (or queue length) is then normalised to this maximum value, firstly by being multiplied by the ratio c=F/maxval if maxval is >F (or greater than the maximum number of grants or acceptances allowed) and c=1 otherwise, and secondly by taking the integer part of the resulting number.

For [Q(i,j)] in Eqn. 12 maxval=15, which is larger than F(=4). Hence the normalised queue matrix becomes

$$[ {Q}_{norm} ( i , j ) ] = [ \begin{matrix}0 & 0 & 1 & 2 \\ 0 & 1 & 2 & 0 \\ 1 & 2 & 0 & 0 \\ 2 & 0 & 0 & 1\end{matrix} ] \qquad Eqn . 13$$

All of these cells or packets are assumed already to be granted by the output ports and accepted by the input ports. The request matrix presented to the second “no overbooking” stage is the difference between the original queue matrix and the normalised queue matrix, i.e. the remaining requests

$$\begin{matrix}{[ r ( i , j ) ]}_{output} = [ Q ( i , j ) ] - [ {Q}_{norm} ( i , j ) ] \\ = [ \begin{matrix}1 & 2 & 4 & 8 \\ 2 & 4 & 8 & 1 \\ 4 & 8 & 1 & 2 \\ 8 & 1 & 2 & 4\end{matrix} ] - [ \begin{matrix}0 & 0 & 1 & 2 \\ 0 & 1 & 2 & 0 \\ 1 & 2 & 0 & 0 \\ 2 & 0 & 0 & 1\end{matrix} ] \\ = [ \begin{matrix}1 & 2 & 3 & 6 \\ 2 & 3 & 6 & 1 \\ 3 & 6 & 1 & 2 \\ 6 & 1 & 2 & 3\end{matrix} ]\end{matrix} \qquad Eqn . 14$$

These requests are used by the “no overbooking” stage to fill up the remaining available time slots in the frame as much as possible.

Single-Level Matching “No Overbooking” Stage Output Booking Phase

The number of requests in effect already granted by the output ports in the normalisation stage is

$$[ {\sum }_{i} {Q}_{norm} ( i , j ) ] = [ \begin{matrix}3 & 3 & 3 & 3\end{matrix} ] \qquad Eqn . 15$$

The remaining number of grants available in each output port is therefore
[F F F F]−[3 3 3 3]=[1 1 1 1] Eqn. 16

Output booking operates simultaneously in each output port in the three following steps:
1. if the total number of requests received by the port is less than the remaining number of grants available, then all requests to the port are granted.
2. if the number of VOQs with an unsatisfied request destined for the port is less than or equal to the remaining number of grants, then the VOQs receive one grant each. This step is repeated as many times as possible.
3. taking the VOQs in turn, starting from the one indicated by a pointer, each VOQ with an unsatisfied request receives one grant until the total number of grants given by the port reaches the remaining number of grants in Eqn. 16.

Step 1 does not apply in this case, because the total number of requests

$${[ {\sum }_{i} r ( i , j ) ]}_{output}$$

is 12 to all ports (from Eqn. 14). Step 2 does not apply either, because there are 4 VOQs with unsatisfied requests destined for every output port and only one available grant each. Step 3 applies in this case.

Single-Level Matching Pointer Update Rules

A deterministic NOB25 pointer up-date rule such as that described by Bianco et al initialises the pointers so that each output port gives priority to a different input port (and vice versa) and the pointer advances by 1 each frame, such that on cycle k of the algorithm (i.e. for the k-th frame, starting at k=0), port P gives priority to port p, where
p=1+[(LN−P +k)_{mod LN}] Eqn. 17

Hence in the first frame k=0, with LN=4 in this example, output port 1 points to input port 4, 2 points to 3, 3 points to 2 and 4 points to 1, i.e. the pointers point to VOQ requests r(4,1), r(3,2), r(2,3) and r(1,4) in Eqn. 14. All of these VOQs have 6 requests, and because Eqn. 16 allows only 1 more available grant for each output port, each of these four VOQs will be granted one more request, i.e. the additional output booking grants [g(i,j)] are given by

$$[ g ( i , j ) ] = [ \begin{matrix}0 & 0 & 0 & 1 \\ 0 & 0 & 1 & 0 \\ 0 & 1 & 0 & 0 \\ 1 & 0 & 0 & 0\end{matrix} ] \qquad Eqn . 18$$

Single-Level Matching “No Overbooking” Stage Input Booking Phase

The number of requests in effect already accepted by the input ports in the normalisation phase is

$$[ {\sum }_{j} {Q}_{norm} ( i , j ) ] = [ \begin{matrix}3 \\ 3 \\ 3 \\ 3\end{matrix} ] \qquad Eqn . 19$$

The remaining number of additional acceptances available in each input port is therefore

$$[ \begin{matrix}F \\ F \\ F \\ F\end{matrix} ] = - [ {\sum }_{j} {Q}_{norm} ( i , j ) ] = [ \begin{matrix}4 \\ 4 \\ 4 \\ 4\end{matrix} ] - [ \begin{matrix}3 \\ 3 \\ 3 \\ 3\end{matrix} ] = [ \begin{matrix}1 \\ 1 \\ 1 \\ 1\end{matrix} ] \qquad Eqn . 20$$

The request matrix for this input booking phase is the additional output booking grants matrix [g(i,j)] (Eqn. 18). Step 2 of the “no overbooking” algorithm applies, so all of the additional output booking grants are accepted, i.e. the additional input booking acceptances [a_{additional}(i,j)] are given by

$$[ {a}_{additional} ( i , j ) ] = [ \begin{matrix}0 & 0 & 0 & 1 \\ 0 & 0 & 1 & 0 \\ 0 & 1 & 0 & 0 \\ 1 & 0 & 0 & 0\end{matrix} ] \qquad Eqn . 21$$

The final acceptance matrix is the sum of the acceptances from the initial normalisation (Eqn. 13) plus these additional acceptances from the “no overbooking” algorithm (Eqn. 21),

$$\begin{matrix}[ a ( i , j ) ] = [ {Q}_{norm} ( i , j ) ] + [ {a}_{additional} ( i , j ) ] \\ = [ \begin{matrix}0 & 0 & 1 & 2 \\ 0 & 1 & 2 & 0 \\ 1 & 2 & 0 & 0 \\ 2 & 0 & 0 & 1\end{matrix} ] + [ \begin{matrix}0 & 0 & 0 & 1 \\ 0 & 0 & 1 & 0 \\ 0 & 1 & 0 & 0 \\ 1 & 0 & 0 & 0\end{matrix} ] \\ = [ \begin{matrix}0 & 0 & 1 & 3 \\ 0 & 1 & 3 & 0 \\ 1 & 3 & 0 & 0 \\ 3 & 0 & 0 & 1\end{matrix} ]\end{matrix} \qquad Eqn . 22$$

All input and output ports fill all F=4 time slots in this first frame. A full set of 16 cell or packet requests has been accepted in the first cycle or frame. They are taken from 8 of the longest VOQs in Eqn. 12.

A matching algorithm may not completely fill up the matrix of Accepted-Requests from the matrix R (i.e., ensure A-R=a null matrix, indicating all requests have been granted). This is partly because A is constrained by the fact that the sum of elements a(i,j) in each row and column cannot exceed the number of timeslots in a frame length, F. Referring now back to the example request matrix given in Eqn. 3 and with frame duration F=8 timeslots, then both

$${\sum }_{i = 1}^{4} {a}_{i , j}^{′} \leq 8 ∀ j and {\sum }_{j = 1}^{4} {a}_{i , j} 8 ∀ i$$

and by the constraint that the total of the sums of elements in each column and each row is limited to the total number of available timeslots N×“F”, i.e.,

$${\sum }_{i = 1}^{4} {\sum }_{j = 1}^{4} {a}_{i , j} \leq N \times F ,$$

where N=4 and F=8 in this example. This is the maximum possible number of acceptances for the frame. But the matching algorithm may not be able to achieve this maximum number.

Thus, as a more specific example, consider where the matching algorithm populates a matrix of Accepted-Requests as follows:

$$A = ( \begin{matrix}2 & 4 & 2 & 0 \\ 3 & 0 & 1 & 0 \\ 2 & 3 & 1 & 2 \\ 1 & 0 & 2 & 5\end{matrix} )$$

Here F=8 and N×F=32, however,

$${\sum }_{i = 1}^{4} {\sum }_{j = 1}^{4} {a}_{i , j} = 28$$

meaning that the maximum switch capacity of 32 requests per time period of 8 time slots has not been utilised.

The above example illustrates clearly one limitation of such a known frame-based matching process, in that the switch capacity may not be utilised fully, resulting in some redundant switch capacity in any given frame.

The present invention seeks to obviate and/or mitigate some of the problems related to optmising matching algorithms so that their computational complexity is further reduced, yet which can more efficiently utilise the switch capacity. Ideally the computational complexity is reduced to a level which is suitable for the high-speed switches which are currently being developed for future use. The invention provides a frame based matching algorithm which seeks to obviate and/or mitigate some of the problems known in the art related to optimising matching algorithms by seeking to further reduce the number of computing steps in a frame-based matching process from O(LN) to O(L) or O(N) for the frame.

A first aspect of the invention provides a matching method for a number N of first elements, each first element arranged to at least provide ingress to a switch arrangement, each of the first N elements comprising a number L₁ of first sub-elements, the switch arrangement having a number ML₂ of second sub-elements arranged to at least provide egress from said switch arrangement, and wherein each of the first L₁ sub-elements is capable of conveying a service request for at least one of said second sub-elements ML₂, wherein the method comprises: firstly, for every one of the N first elements, aggregating service requests from all L₁ first sub-elements to each of the ML₂ second sub-elements, and secondly, resolving contention for said service requests from all N first elements to one or more of said second ML₂ sub-elements, and thirdly, for each first element, resolving contention between the L₁ sub-elements and said second ML₂ sub-elements.

The step of resolving contention between the L₁ sub-elements and said second ML₂ sub-elements may be performed in parallel for each said first element.

The ML₂ second sub-elements of the switch arrangement may be provided as a number M of second elements, each of said M second elements being associated with a number L₂ of second sub-elements.

Each sub-element may be capable of generating at least one said service request.

The first sub-elements and said second sub-elements may be bi-directional and provide both ingress and egress from the switch fabric. The first sub-elements may comprise said second sub-elements.

The first sub-elements and said second sub-elements may be unidirectional and then said first sub-elements may provide ingress and said second sub-elements may provide egress from the switch arrangement.

The first and second sub-elements may comprise ports in the switch arrangement and said first elements comprise aggregations of said first sub-elements.

The first and second sub-elements may comprise ports in the switch arrangement, and the first elements may comprise aggregations of said first sub-elements and said second elements comprise aggregations of said second sub-elements.

The switch arrangement may comprise an input queued cell switch and said service requests comprise requests for transmitting a service information rate from one of said first sub-elements to at least one of said second sub-elements.

The switch arrangement may comprise an input queued cell switch and said service requests comprise requests for transmitting at least one cell from one of said first sub-elements to at least one of said second sub-elements.

The switch arrangement may comprise an input queued packet switch and said service requests comprise requests for transmitting a service information rate from one of said first sub-elements to at least one of said second sub-elements.

The switch arrangement may comprise an input queued packet switch and said service requests comprise requests for transmitting at least one packet from one of said first sub-elements to at least one of said second sub-elements.

The packets may have a fixed-length and comprise cells and said packet switch may be an input queued cell switch arranged to switch fixed-length cells, and said service requests may comprise requests for transmitting one or more fixed-size cells from one of said first sub-elements to one or more of said second sub-elements.

The packets may have a fixed-length and comprise cells and said packet switch may be an input queued cell switch arranged to switch fixed-length cells, and said service requests may comprise requests for transmitting a service information rate from one of said first sub-elements L₁ to one or more of said second sub-elements L₂.

The switch arrangement may comprise a circuit based switch and said service request comprises a request for a connection in a circuit-based switch. The switch arrangement may comprise a circuit based switch and said service request comprises a request for a bandwidth in a circuit-based switch. The switch arrangement may comprise a circuit based switch and said service request comprises a request for a service information rate in a circuit-based switch. The service information rate may be a bit rate.

The circuit based switch arrangement may comprise at least one switch taken from the group consisting of: any known time-domain, frequency domain, wavelength domain or space domain switching technologies. The circuit-based switch arrangement may comprise a combination of said switches.

The switch arrangement may comprise a network, and said elements may comprise aggregations of network terminals or nodes and said sub-elements may comprise network terminals or nodes. The switch arrangement may comprise an arrangement of inter-connectable sub-networks, where said elements comprise sub-networks and said sub-elements comprise network terminals or nodes.

The network may be an optical network. The sub-networks may comprise optical networks.

The elements may become sub-elements with respect to elements in a higher layer of matching. Multiple layers of matching may be performed in a hierarchy of matching levels.

A second aspect of the invention provides a method as claimed in any previous claim, wherein the method of matching comprises: firstly, aggregating service requests to the highest level of the matching hierarchy, and secondly, resolving contention for said service requests at the highest level of the matching hierarchy, and thirdly, resolving contention in turn down through the matching levels to the lowest level of matching.

A third aspect of the invention seeks to provide a matching method for a switch arrangement comprising a plurality N of input elements, each input element comprising a plurality (L₁) of input sub-elements, and a plurality M of output elements, each output element comprising a plurality L₂ of output sub-elements, the matching method comprising the following steps: performing a first matching across the switch fabric for each of the plurality of N input elements and the ML₂ sub-elements by performing the steps of: summing a number of requests from each of the L₁ sub-elements of the input element; generating a first N×ML₂ request matrix; matching the first request matrix to generate a first matrix of accepted requests; and performing a second matching across the switch fabric for each of the N input elements by performing the steps of: generating N asymmetric second L₁×ML₂ matrices, for each of the N input elements; and matching each of the N asymmetric second matrices to generate N second matrices of accepted requests; and generating a NL₁×ML₂ matrix of accepted requests from the first N×ML₂ matrix of accepted requests and the N second L₁×ML₂ accepted request matrices.

The NL₁×ML₂ matrix of requests may be symmetric. L₁ may be equal to L₂ and N may be equal to M. The N second L₁×ML₂ matrices may be asymmetric or symmetric

The sub-elements may comprise ports on a switch. The sub-elements may comprise nodes or terminals in an optical network. The sub-elements may comprise nodes in an optical ring network. The sub-elements may comprise terminals in a passive optical network (whether amplified or not).

The switch arrangement may comprise a packet switch arrangement. The packet switch arrangement may be capable of switching fixed-length packets. The switch arrangement may comprise a cell switching arrangement. The cell switching arrangement may be capable of switching packets.

A fourth aspect of the invention seeks to provide a switch arrangement, the switch arrangement having number N of first elements, each first element arranged to at least provide ingress to a switch arrangement, each of the first N elements comprising a number L₁ of first sub-elements, the switch arrangement having a number ML₂ of second sub-elements arranged to at least provide egress from said switch arrangement, and wherein each of the first L₁ sub-elements is capable of conveying a service request for at least one of said second sub-elements ML₂, wherein said service requests are conveyed by performing a matching method which comprises: firstly, for every one of the N first elements, aggregating service requests from all L₁ first sub-elements to each of the ML₂ second sub-elements, and secondly, resolving contention for said service requests from all N first elements to one or more of said second ML₂ sub-elements, and thirdly, for each first element, resolving contention between the L₁ sub-elements and said second ML₂ sub-elements.

In the fourth aspect, the matching method may be according to any one of the first, second or third aspects.

A fifth aspect of the invention seeks to provide a network including a switch arrangement according to the fourth aspect.

A sixth aspect of the invention seeks to provide a suite of at least one computer programs arranged when executed to implement steps in a method according to the first, second or third aspects. At least one program may be arranged to be implemented by software running on a suitable computational device. At least one program may be arranged to be implemented by suitably configured hardware.

A sixth aspect of the invention seeks to provide a scheduler for a switching arrangement, the scheduler arranged to perform a scheduling process, the scheduling process comprising: a matching method according to any one of the first, second or third aspects; and a time-slot assignment process.

A seventh aspect of the invention seeks to provide a matching method according to any one of the first, second or third aspects wherein the sub-elements comprise ports, and the matching updates the pointers to input ports according to the following rule: pₒᵤₜ=1+[(LN−Pᵢₙ+k)_{mod LN}] and the output ports are updated according to the following rule: pᵢₙ=1+[(LN−Pₒᵤₜ+k)_{mod L}]

An eighth aspect of the invention seeks to provide a matching method according to any one of the first, second or third aspects wherein the sub-elements comprise ports, and the matching updates the pointers to input ports according to the following rule: pₒᵤₜ=1+[(LN−Pᵢₙ+k)_{mod LN}] and the output ports are updated according to the following rule: pᵢₙ=1+[(m−Pₒᵤₜ+k)_{mod L}]

In any matching method aspect of the invention, the method may be arranged to enable a multicast matching scheme to be implemented.

In any matching method aspect of the invention, the ML₂ output sub-elements may be grouped first into M groups of L₂ sub-elements, and matching may be performed first at the group level between the N groups of L₁ input sub-elements and the M groups of L₂ output sub-elements, and then, for each of the N groups of L₁ input sub-elements, between the L₁ individual input sub-elements and the M groups of L₂ output sub-elements.

A ninth aspect of the invention seeks to provide a matching method for a number N of first elements, each first element arranged to at least provide ingress to a switch arrangement, each of the first N elements comprising a number L₁ of first sub-elements, the switch arrangement having a number ML₂ of second sub-elements arranged to at least provide egress from said switch arrangement, and wherein each of the first L₁ sub-elements is capable of conveying a service request for at least one of said second sub-elements ML₂, wherein the ML₂ sub-elements are grouped into M aggregations of L₂ sub-elements, and the method comprises: firstly, for every one of the N first elements, aggregating service requests from all L₁ first sub-elements to each of the M aggregations of L₂ second sub-elements, and secondly, resolving contention for said service requests from all N first elements to one or more of said M aggregations of L₂ second sub-elements, and thirdly, for each first element, resolving contention between the. L₁ sub-elements and said M aggregations of L₂ second sub-elements.

Another aspect of the invention seeks to provide a matching method for a multi-stage switch arrangement having a plurality of logically associated inputs and a plurality of outputs, wherein the matching method comprises the steps of: for each logical association of inputs, aggregating service requests from every one of the inputs which form said logical association; resolving contention for said aggregated service requests between all of the logical associations to the outputs of the switch arrangement; and repeating the above steps in the matching method within each logical association for a subset of the inputs forming each said logical association until contention is resolved between the individual inputs of the switch arrangement and the outputs of the switch arrangement.

Preferably, in each repetition, the number of inputs forming the logical association is reduced until each logical-association of a sub-set comprises a single input to the switch arrangement, said aggregated service requests comprise a single service request, whereby contention is resolved between each input of the switch arrangement and each output of the switch arrangement.

Preferably, each step resolving contention between the outputs of the switch arrangement comprises resolving contention between a logical association of inputs and a logical association of outputs having the same number of inputs.

Preferably, said multi-stage switch arrangement comprises a plurality of switching stages, at least one switching stage comprising: a plurality of switches which logically associated into different sets of switches, each set of switches being logically associated with one of said logical associations of inputs of the switch arrangement, wherein each set of logically associated switches operate only on the inputs of the switch arrangement with which they are logically associated, the switch arrangement further comprising a global spatial switching stage arranged to receive traffic derived from any of the inputs of the switch arrangement via any logically adjacent sets of said switches.

Preferably, said multi-stage switch arrangement comprises a plurality of switching stages, at least one switching stage comprising: a plurality of switches which logically associated into different sets of switches, each set of switches being logically associated with one of said logical associations of outputs of the switch arrangement, wherein each set of logically associated switches operate only to provide output to the outputs of the switch arrangement with which they are logically associated.

Another aspect of the invention seeks to provide a multi-stage switch arrangement arranged to switch time-slotted traffic segments, the switch arrangement comprising: a plurality of switching stages including a spatial switching stage arranged to receive traffic which has been switched by at least one switching stage logically adjacent to the input of spatial switching stage, the spatial switching stage being further arranged to output to at least one switching stage logically adjacent to its output, each of said at least one switching stage logically adjacent to the input of the spatial switching stage comprises a plurality of input aggregation switching stages, each aggregation switching stage being logically associated with a subset of the inputs of the switch arrangement, each of said at least one switching stage logically adjacent to the output of the spatial switching stage comprises a plurality of output aggregation switching stages, each output aggregation switching stage being logically associated with a subset of the outputs of the switch arrangement, the multi-stage switch being further arranged to implement suitable control means to enable the time-slotted traffic to be matched according to the matching method according to any method aspect of the invention.

Advantageously, the invention seeks to provide a scheduling algorithm suitable for a high-performance VOQ IQ switch which has a reduced level of complexity yet supports an acceptable level of throughput. The scheduling algorithm is provided with less computational complexity by performing the matching over several hierarchical levels within and between smaller switches or sub-networks or aggregations of input and output ports, by providing a matching algorithm which operates generally, but not exclusively, on an asymmetric request matrix.

Advantageously, the invention reduces the computing complexity and enables larger cell/packet switches/networks to be constructed without distributing the scheduling decisions too loosely between the smaller switches or sub-networks or aggregations of input and output ports so that performance is degraded.

The asymmetric request matrix grants requests between inputs and outputs of differing levels of aggregation, e.g., switch-port, node aggregation-node, ring-node, or PON-terminal. In general, as more than one hierarchical level of matching is performed between different sub-networks; multistage buffering and switching can be used to support this. Advantageously, however, in some embodiments of the invention, the multi-stage buffering/switching is implemented by means of multi-hopping. Advantageously in such embodiments, buffering remains at the switch/network edge. This means that where the invention is implemented in an otherwise optical network environment, the buffering can be implemented electronically, avoiding the expense of optical buffering technology.

Advantageously, the invention can provide a global frame-based optimal scheduling algorithm which operates both within and between each individual sub-switch/network, the scheduling algorithm comprising a matching algorithm stage and a channel assignment (time-slot assignment) stage. The global frame-based multi-level matching scheme uses multiple aggregation levels. Channel assignment can be provided by any suitable mechanism, for example, one example of a time-slot assignment process is described by the inventors in their United Kingdom Patent Application No. GB-A-0322763.4, the contents of which are hereby incorporated into the description by reference. In a preferred embodiment of the invention the channel assignment stage comprises a method of buffering the timeslot interchanging stages by multi-hopping (3 hops) between sub-sets of the network nodes (terminals) so that buffering can be located at the edge nodes only as described by GB-A-0322763.4.

In contrast to the prior art, the invention may use asymmetric traffic request matrices, applied to different parts of the overall network with different levels of aggregation, in order to reduce the matching complexity. For example, the asymmetric request matrix can be between input switch-output port or upstream ring-downstream node or upstream PON-downstream terminal. This allows sufficient information about individual port, node or terminal identities to be retained to prevent receiver contentions and source blocking, while reducing the overall matching complexity.

The preferred features of the invention (or dependent accompanying claims) can be combined in with any of the aspects of the invention (or independent accompanying claims) in any appropriate manner apparent to those skilled in the art. The invention will now be described with reference to the following drawings which are by way of example only and in which:

FIG. 1 is a sketch of a N×N input queued packet switch;

FIG. 2 is a sketch of a 4×4 input queued packet switch showing virtual output queues VOQs and its corresponding request matrix;

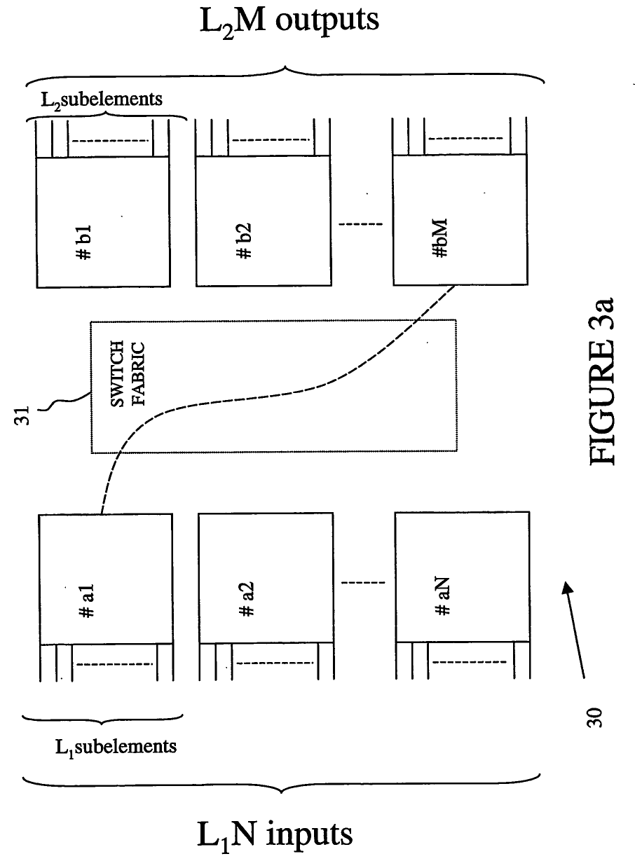

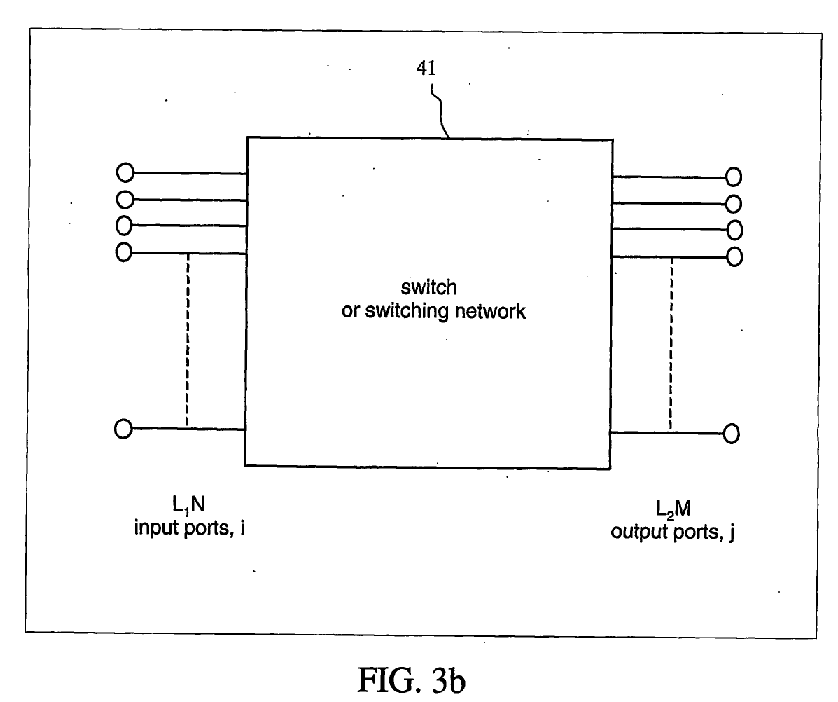

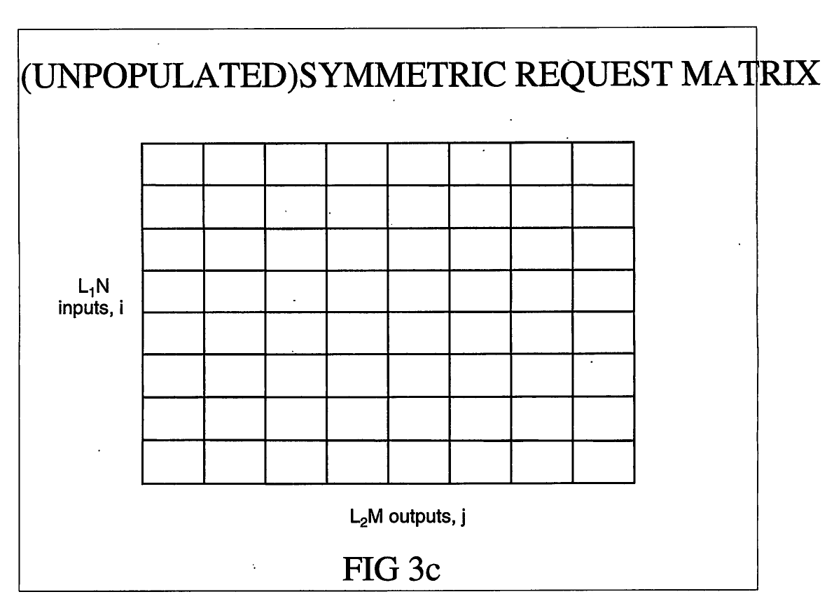

FIG. 3a is a sketch showing the input and output elements and sub-elements of a switch arrangement according to an embodiment of the invention;

FIGS. 3b and 3c show a simplified view of the switch in FIG. 3a and an unpopulated symmetric LN×LN matrix for the switch shown in FIG. 3a respectively;

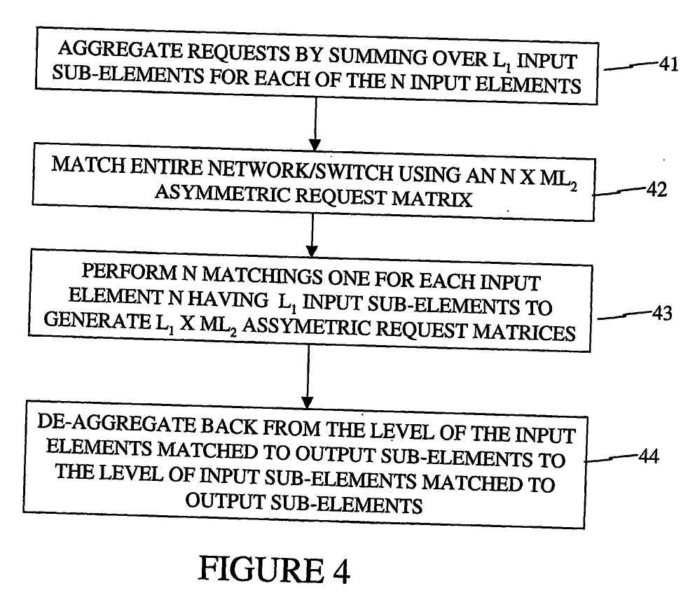

FIG. 4 shows steps in a method according to an embodiment of the invention;

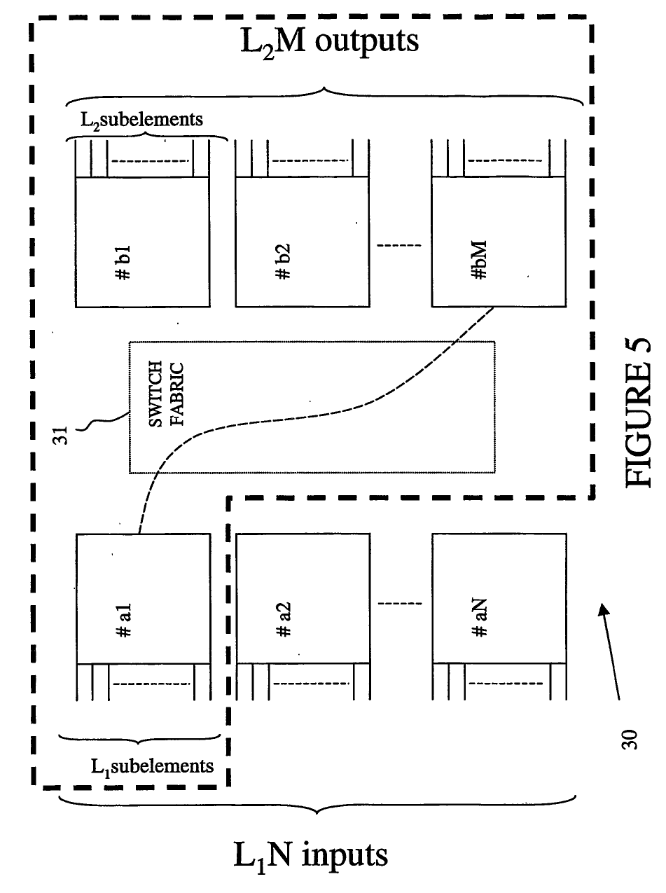

FIG. 5 is a sketch showing schematically the aggregation of requests for the switch shown in FIG. 3a in the first level matching method according to an embodiment of the invention;

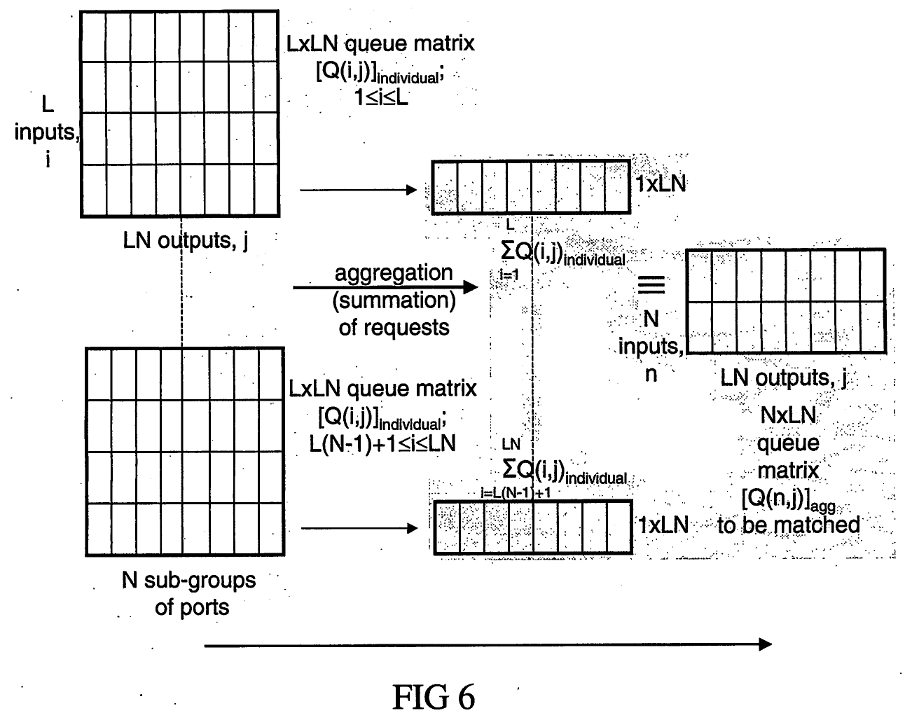

FIG. 6 shows schematically the steps of aggregating requests and the 1^{st} level of matching in multi-level matching scheme according to an embodiment of the invention;

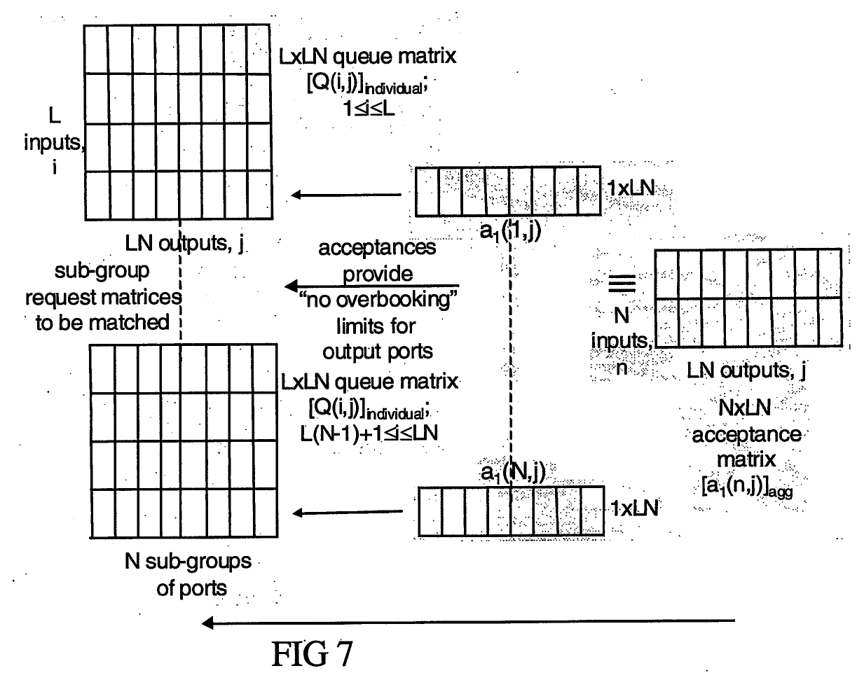

FIG. 7 shows schematically the steps of performing multiple, parallel matchings of N elements, each having L input ports, including de-aggregation, in the 2^{nd} level of a multi-level matching scheme according to the invention; and

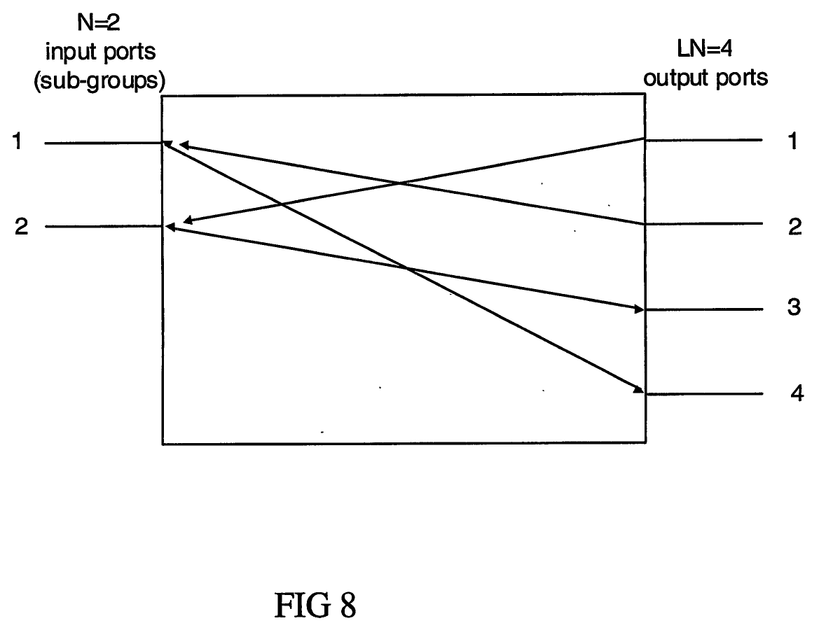

FIG. 8 shows the pointer positions for the 2×4 asymmetric request matrix [r₁(n,j)] in the first cycle or frame (k=0) for a multi-level matching scheme according to an embodiment of the invention.

The best mode of the invention as currently contemplated by the inventors will now be described. This invention relates to the matching part of a frame-based scheduling algorithm. The matching algorithm is able to use multiple levels of aggregation for packet requests. The term packet is used here to refer to multi-cast and unicast packets of fixed length (i.e., fixed as in a cell has a fixed length) or variable length as is apparent to those skilled in the art. The switch arrangements described relate to a number of possible embodiments, including packet, cell, and circuit switching arrangements. A cell switch can additionally include means to switch packets of fixed and/or variable length in some embodiments of the invention.

The invention can be used to match service requests in any switch arrangement provided over a network. For example a matching for service rate requests between ports on any switch can be provided by the invention, as well as a matching on a larger scale between sub-networks within a communications network. For example, the matching process can be used when traffic needs to travel between interconnecting optical networks and rings. As has been mentioned above, the invention can also, in some embodiments, be used to match service requests in a circuit switch environment.

A specific embodiment of the invention will now be described with reference to FIGS. 3a, 3b, and 3c of the accompanying drawings. FIG. 3a shows schematically a switch comprising a number of elements #a1, . . . , #aN and #b1, . . . , #bM between which traffic can be switched over switch fabric 31. Each of the elements #a1, . . . , #aN has a number of sub-elements, and each of the elements #b1, . . . , #bM has a number of sub-elements. The number of sub-elements L₁ may not be equal to the number of sub-elements L₂, and the number of elements N may not equal the number of elements M in some embodiments of the invention. In a preferred embodiment of the invention the product L₁N is equal to the product L₂M, and in the best mode of the invention N=M and L₁=L₂. The sub-elements may comprise unidirectional ingress or egress to the switch fabric, or they each may comprise bi-directional ingress and egress facilities to and from the switch fabric.

In one embodiment of the invention, the elements N, M comprise sub-networks in a network connected by a hub switch fabric, and each sub-element, comprises a node or terminal on each sub-network #a1, . . . , #aN or sub-network #b1, . . . , #bM. For example, consider an embodiment where a switch is arranged to switch traffic moving between different rings and/or networks and needs to be capable of switching traffic at different levels of aggregation, for example between optical networks (particularly passive optical networks PONs). Such a switch needs to have high performance and support fast switching speeds in a reliable and fair manner, as discussed by Bianco et al in their paper on Access Control Protocols for Interconnected WDM Rings in the DAVID Metro Network, IWDC 2001 (International Workshop on Digital Communications), Taormina, Italy, Sep. 17-20, 2001 the contents of which are hereby incorporated by reference.

It will be appreciated by those skilled in the art that whilst FIG. 3 is described with reference to elements and sub-elements, there is a clear analogy to embodiments in which the elements comprise, for example, different terminals or ports of a switch, or different terminals of a network, or different terminals of a sub-network, or a sub-network having a number of different terminals, or a switch having a number of terminals or ports.

In the prior art, it is known to perform the matching between the input and output ports or terminals of a switch or network conventionally in one operation or hierarchical level. The preferred embodiment of the invention proposes a matching scheme for a switching arrangement comprising a number of input sub-elements (for example ports or terminals) which are grouped into elements and the matching is performed in more than one hierarchical level in a global, end-to-end manner.

The invention seeks to increase the amount of parallel processing that can be performed in the matching and reduce the computing steps required for the matching. The elements can, in some embodiments of the invention, be arbitrary sub-sets of the sub-elements, for example, the sub-elements could comprise ports (terminals) without any particular physical significance or in alternative embodiments comprise ports on real sub-networks. For example, if the switch input and output elements comprise rings in an interconnecting switching arrangement of rings, then the input and output sub-elements could comprise the individual nodes or terminals. Alternatively, if the switching arrangement is a large switch comprising a plurality of interconnected smaller switches, then the sub-elements could comprise the ports on smaller switches.

This invention therefore provides a global matching algorithm for use in either single-stage or multi-stage switching and buffering networks, without resorting to complete autonomy of the smaller elements (i.e. sub-sets of ports or terminals, switches or sub-networks), nor aggregating requests at too high a level (e.g. ring-ring or PON-PON). The invention provides a matching method in which the sub-elements (e.g., the ports or terminals) are grouped into elements and the matching is performed in more than one hierarchical level, and in a global, end-to-end manner. This has the benefit of increasing the amount of parallel processing that can be performed in the matching and reducing the computing steps required for the matching.

As described with reference to the prior art, matching algorithms conventionally make use of symmetric traffic request matrices between cell- or packet-switch ports, or between rings or PONs in packet networks, or between nodes or terminals in packet networks. But this invention employs traffic request matrices which are in general (but not exclusively) asymmetric, and which are applied to different parts of the overall network with different levels of aggregation, in order to reduce the matching complexity. For example, at a first level of aggregation the matching may be between input elements and output sub-elements, and a second level of matching may be between input sub-elements and output sub-elements. In this way, an asymmetric request matrix can be generated for service requests between an input switch element and an output port of an output switch element. Alternatively, an asymmetric matrix could be generated between an upstream ring element and a downstream node sub-element or alternatively, an upstream PON element and a downstream terminal sub-element.

By providing a two-level, global (i.e., end to end) matching process between the elements and sub-elements and sub-elements to sub-elements, sufficient information about individual port, node or terminal identities can be retained to prevent receiver contentions and source blocking, while reducing the overall matching complexity.

In some embodiments of the invention, more than one level of aggregation can be implemented in the matching method, and as such elements become sub-elements with respect to elements in a higher layer of matching. For example, it is possible for multiple layers of matching to be performed in a hierarchy of matching levels in some embodiments of the invention. As an example, one method of matching according to an embodiment of the invention comprises the following steps:
firstly, aggregating service requests to the highest level of the matching hierarchy, and
secondly, resolving contention for said service requests at the highest level of the matching hierarchy, and
thirdly, resolving contention in turn down through the matching levels to the lowest level of matching.

In FIG. 3a, a switch 31 is shown schematically to be arranged to switch traffic between a number of elements N (denoted #a1, . . . , #aN), each having L₁ sub-elements across a suitable switch fabric 31 (for example a hub) to a number of output sub-elements, here ML₂ in number. Each element a#1, . . . , a#N comprises a number of different sub-elements L₁, and in FIG. 3a, an embodiment of the invention is shown where the ML₂ sub-elements are shown aggregated into M groups of L₂ sub-elements. The grouping (or aggregation) of the output sub-elements into M elements, does not occur in other embodiments of the invention. Switch 31 therefore comprises NL₁ inputs and ML₂ outputs, i.e., switch 31 effectively comprises an NL₁×ML₂ switch. As an example, consider an optical embodiment of the invention where aggregation of both inputs and outputs may be present if the N, M elements are PONs or optical ring networks as then both the L₁ and L₂ sub-elements may comprise user terminals or nodes.

FIG. 3b shows a simplified representation of the switching arrangement showed in FIG. 3a, which illustrates more clearly the sub-elements forming the inputs and outputs of the switch 31. In FIG. 3b, switching arrangement 40 comprises L₁N input sub-elements i (for example ports) and L₂M output sub-elements j (for example ports) j. A conventional matching algorithm for frame-based scheduling such as that which Bianco et al describe employs multiple phases for matching, such as was described referring to the prior art. Such a conventional technique produces a match for a symmetric request matrix, L₁N×L₂M (or if N=M and L₁=L₂=L, LN×LN) in size such as is shown in FIG. 3c (where a grid is shown as the matrix as yet unpopulated).

Asymmetric, Multi-Stage Matching Using Multiple Levels of Aggregation

Referring now to FIG. 4 of the accompanying drawings, an overview of the steps in a matching method according to the invention is shown suitable for the switch environment shown in FIGS. 3a,3b, and 3c of the accompanying drawings.

Where a conventional input queued switch arrangement is being considered, the term sub-element is used to refer to any ports and the term element then refers to an aggregation of such ports. Where the switch arrangement is provided by a network element interconnecting a number of optical networks (for example, an optical ring network, or passive optical networks (PONs), the term sub-element is used to refer to any nodes on the rings or terminals on the PONs and the term element refers to an aggregation of such nodes or terminals, for example, the term element could refer as such to a ring network or a PON.

As has been mentioned, in some embodiments of the invention, the switch arrangement comprises part of a network, and the network comprises interconnected sub-networks. In such embodiments, at one hierarchical level the sub-networks are the elements, and the nodes or terminals in each sub-network comprise the sub-elements sub-element. For example, where the switch arrangement is provided by a network element interconnecting a number of optical networks (for example, passive optical networks (PONs)), the term sub-element is used to refer to any nodes or terminals on the PONs and the term element can refer to the PON. As will be appreciated by those skilled in the art, the hierarchical matching process according to the invention is not limited to such embodiments, but may be implemented in any switching environment where differing levels of aggregation can be effected at least for the inputs to the switch arrangement.

In FIG. 4, an algorithm according to one embodiment of the invention is shown in which NL₁ input sub-elements are capable of generating service requests for ML₂ output sub-elements over a switch fabric. The NL₁ input sub-elements are aggregated as N elements #a1, . . . , #aN, each element comprising L₁ sub-elements. The ML₂ output sub-elements may be aggregated into M elements, each element comprising L₂ sub-elements in some embodiments of the invention, but need not be so aggregated in other embodiments of the invention. In FIG. 4, the L₂ sub-elements are aggregated into M=N elements, #b1, . . . , #bM. Aggregation for each of the N elements #a1, . . . , #aN of the switch arrangement is initially performed in step 41 by summing the total number of requests for each of the L₁ sub-elements of each of the N elements, i.e., for each element the total number of requests destined for each of the ML₂ sub-elements is summed over its L₁ input ports in step 41. Each element N can be considered alternatively as a group of sub-elements.

A first matching is then performed in which the service requests are matched at a first aggregation level by generating an asymmetric N×ML₂ request matrix for each of the N input elements in step 42. The notation used here means that the matrix has N rows and ML₂ columns, where N is an integer and ML₂ is an integer.

A second matching process is then performed in step 43 in which N separate matchings are performed, one for each of the N elements comprising L₁ sub-elements (input ports). This involves N separate L₁×L₂ M asymmetric request matrices. De-aggregation is thereby performed back from the aggregate level of the N elements to the ML₂ output subs elements (i.e., output ports) to the aggregate level of L₁ input ports to ML₂ output ports in step 44. It will be appreciated by those skilled in the art that the N matchings of step 43 could of course be performed sequentially, but it is advantageous in terms of the total time taken to run the algorithm if the number of computing steps (times) can be reduced by performing them simultaneously, in parallel, using multiple matching “processors”. The latter is the preferred approach and is adopted in the best mode of the invention currently contemplated by the inventors. It is also possible for the number of elements and sub-elements to differ on each side of the switch as has been mentioned before.

Aggregation of Requests

FIG. 5 shows schematically how each of the L₁ sub-elements of input element #a1 in FIG. 3a is initially aggregated into a group of sub-elements. Strictly speaking, because the particular matching algorithm being used as an example takes the queue lengths as inputs for its first normalisation stage, the requests in this step are simply the queue lengths. (However, the number of requests could be any alternative number of requests for cells/packets to be switched, using other criteria for calculating that number. For example, each VOQ request used could be calculated as the queue length limited to a maximum of F requests for the next frame).

FIG. 6 shows the aggregation of request step 41 and the first level of matching step 42 of FIG. 4 in more detail. In FIG. 6, N=M, and L₁=L₂=L for simplicity.

In FIG. 6, there are N groups of L sub-elements (here a sub-element comprises an input port). Each element employs an L×LN asymmetric queue matrix [Q(i,j)]_{individual} to represent the numbers of backlogged cells/packets in each input port of the element destined for each output port of the switch arrangement (i.e., of the switch or switching network as appropriate).

Each L×LN matrix [Q(i,j)]_{individual} is simply that portion of the global LN×LN [Q(i,j)] matrix for all VOQs of the entire switch or switching network relating to that particular element comprising a group of L sub-elements. Thus each element (alternatively each group of input ports) has all its input port-output port requests recorded. The queue lengths of all input ports in each [Q(i,j)]_{individual} matrix are then aggregated (summed) into N aggregated queue matrices, each aggregated queue matrix having the form of a 1×LN matrix. The N aggregated queue matrices are equivalent to a single N×LN aggregated queue matrix [Q(n,j)]_{agg} representing the traffic queued in the N groups of input ports for the output ports of the switch arrangement.

1^{st} Level of Matching

The first level of matching is just one matching covering the entire switch or network. It takes the N×LN asymmetric, aggregated queue matrix [Q(n,j)]_{agg} as its input, as shown in FIG. 1.

Output and input booking using the example matching algorithm are summarised as follows. Outputs for the matching still represent the overall output ports of the switch, but inputs represent here the N elements, each element comprising a group of sub-elements (i.e. a group of input ports). The matrices now possess an index representing the 1^{st} or 2^{nd} level of matching.

Firstly, the aggregated queue matrix undergoes a normalisation stage:
[Q(n,j)]_{agg} [symbol] [Qₙₒᵣₘ(n,j)]_{agg}, [r₁(n,j)]

Then the output booking and input booking phases described herein above are performed in a similar manner:

$$Output Booking phase \text{:} [ {r}_{1} ( n , j ) ] ⇒ [ {g}_{1} ( n , j ) ] ; {\sum }_{n} {g}_{1} ( n , j ) \leq F - {[ {\sum }_{n} {Q}_{norm} ( n , j ) ]}_{agg}$$

$$Input Booking phase \text{:} [ {g}_{1} ( n , j ) ] ⇒ [ {a}_{1} ( n , j ) ] ; {\sum }_{j} {a}_{1} ( n , j ) \leq F$$

Here the g₁(i,j) are elements in the first matrix of granted requests and the a₁(i,j) are elements in the first matrix of accepted grants.

2^{nd} Level of Matching

FIG. 7 shows in more detail steps 43 and 44 in which multiple, parallel matchings of N elements of input ports, including de-aggregation, are performed in the second level of matching. In the 2^{nd} level of multi-level matching the aggregated acceptances in the acceptance matrix [a₁(n,j)] from the 1^{st} stage of matching provide the limits for matching between the overall input and output ports within each of the N groups of input ports, i.e., within each of the N elements. The input for the matching within each element or group of sub-elements is taken as the original L×LN asymmetric queue matrix [Q(i,j)]_{individual}. Performing the matchings automatically provides de-aggregation back from the level of the grouped input ports-output ports to individual input ports-output ports. Normalisation and output and input booking are then performed in the manner described below. In this 2^{nd} level, outputs and inputs of the matching once again represent the overall output and input ports of the switch/network.

$$Normalisation stage {\text{:} [ Q ( i , j ) ]}_{individual} ⇒ {[ {Q}_{norm} ( i , j ) ]}_{individual} , [ {r}_{2} ( i , j ) ]$$

$$Output Booking phase \text{:} [ {r}_{2} ( i , j ) ] ⇒ [ {g}_{2} ( i , j ) ] ; {\sum }_{i} {g}_{2} ( i , j ) \leq {a}_{1} ( n , j ) - {[ {\sum }_{i} {Q}_{norm} ( i , j ) ]}_{individual}$$

Here the g₂(i,j) are elements in the second matrix of granted requests and the a₂(i,j) are elements in the second matrix of accepted grants.

The summation is taken over only the input ports within an element, and the value of n in the summation is obviously the identity of that element.

$$Input Booking phase \text{:} [ {g}_{2} ( i , j ) ] ⇒ [ {a}_{2} ( i , j ) ] ; {\sum }_{j} {a}_{2} ( i , j ) \leq F$$

An Example Demonstrating a Specific Embodiment of the Invention—Multi-Level Matching-Aggregation

As a simple example of the hierarchical, multi-level matching principle, it is possible to partition the overall queue matrix [Q(i,j)] for the switch in Eqn. 1 into N=2 elements each comprising L=2 input ports (i.e., N=2 groups of L=2 sub-elements), and to aggregate the requests (queue lengths) destined from the same group of input ports to each output port into a single 2×4 matrix, i.e.

$$\begin{matrix}[ \begin{matrix}1 & 2 & 4 & 8 \\ 2 & 4 & 8 & 1\end{matrix} ] \\ {[ Q ( i , j ) ]}_{individual} -> {[ Q ( n , j ) ]}_{agg} = \\ {[ {\sum }_{i} Q ( i , j ) ]}_{individual} = [ \begin{matrix}3 & 6 & 12 & 9 \\ 12 & 9 & 3 & 6\end{matrix} ] \\ [ \begin{matrix}4 & 8 & 1 & 2 \\ 8 & 1 & 2 & 4\end{matrix} ]\end{matrix} \qquad Eqn . 23$$

Multi-Level Matching—The First-Level Matching Normalisation Stage

Because the input “ports” for this matrix are the elements (i.e., the groups of input ports), the row-sums over the elements are obviously larger, typically, than the column sums over output ports (which have not been aggregated). We will define maxval as the maximum column-sum or (row-sum/L), the latter being (row-sum/2) in this example, because each element or group of sub-elements contains L=2 input ports. With this definition, maxval is again 15, and every queue length is multiplied by the ratio F/15=4/15 and the integer part of the resulting number is taken. Hence the normalised queue matrix becomes

$${[ {Q}_{norm} ( n , j ) ]}_{agg} = [ \begin{matrix}0 & 1 & 3 & 2 \\ 3 & 2 & 0 & 1\end{matrix} ] \qquad Eqn . 24$$

All of these cells or packets are assumed already to be granted by the output ports and accepted by the elements at the group level for the sub-elements of that element. The request matrix presented to the next “no overbooking” stage is the difference between the original queue matrix and the normalised queue matrix, i.e. the remaining requests

$$\begin{matrix}[ {r}_{1} ( n , j ) ] = {[ Q ( n , j ) ]}_{agg} - {[ {Q}_{norm} ( n , j ) ]}_{agg} \\ = [ \begin{matrix}3 & 6 & 12 & 9 \\ 12 & 9 & 3 & 6\end{matrix} ] - [ \begin{matrix}0 & 1 & 3 & 2 \\ 3 & 2 & 0 & 1\end{matrix} ] \\ = [ \begin{matrix}3 & 5 & 9 & 7 \\ 9 & 7 & 3 & 5\end{matrix} ]\end{matrix} \qquad Eqn . 25$$

Multi-Level Matching—The First-Level Matching “No Overbooking” Stage—Output Booking Phase

The number of requests in effect already granted by the output ports in the normalisation stage is

$${[ {\sum }_{n} {Q}_{norm} ( n , j ) ]}_{agg} = [ \begin{matrix}3 & 3 & 3 & 3\end{matrix} ] \qquad Eqn . 26$$

These are precisely the same numbers as were granted by the normalisation stage in conventional single-level matching (Eqn. 4).

Once again, the remaining number of grants available in each output port is therefore
[F F F F]−[3 3 3 3]=[1 1 1 1] Eqn. 27

Step 3 of the “no overbooking” algorithm described by Bianco et al applies again. But the NOB25 pointer up-date rule needs to be modified for the asymmetric request matrix [r₁(n,j)], to ensure that input ports and output ports point to each other, even though there are different numbers of each. (NB the N input ports are synonymous at this 1^{st} matching level with the N groups of overall input ports). Input and output ports for this 1^{st}-level matching now require slightly different relationships between ports, i.e.

Multi-Level Matching—The First-Level Matching Pointer Up-Date Rule for Asymmetric Request Matrix:
for input ports: pₒᵤₜ=1+[(LN−Pᵢₙ+k)_{mod LN}]
for output ports: pᵢₙ32 1+[(LN−Pₒᵤₜ+k)_{mod L}] Eqn. 28

In our example with L=2 and N=2, this becomes
pₒᵤₜ=1+[(4−Pᵢₙ+k)_{mod 4}]
pᵢₙ=1+[(4−Pₒᵤₜ+k)_{mod 2}] Eqn. 29

FIG. 8 summarises the pointer positions for the 2×4 asymmetric request matrix [r₁(n,j)] in the first cycle or frame (k=0). In any cycle (frame) k, two input ports point to two output ports, each of which output ports points back to the same input port that points to it. The remaining two output ports also point to the two input ports. Hence each input port is pointed to by two output ports, but only two of the four output ports are pointed to by input ports. After 4 cycles or frames, each input port has pointed to each output port once in turn, and each output port has pointed to each input port twice.

Hence in the first frame k=0, with L=2 and N=2 in this example, output port 1 points to input port 2, 2 points to 1, 3 points to 2 and 4 points to 1, i.e. the pointers point to requests r(2,1), r(1,2), r(2,3) and r(1,4) in Eqn. 13. All of these matrix elements have more than one request, and because Eqn. 27 allows only 1 more available grant for each output port, each of these four matrix elements will be granted one more request, i.e.

$$additional output booking grants , [ {g}_{1} ( n , j ) ] = [ \begin{matrix}0 & 1 & 0 & 1 \\ 1 & 0 & 1 & 0\end{matrix} ] \qquad Eqn . 30$$

Multi-Level Matching—The First-Level Matching “No Overbooking” Stage—Input Booking Phase

From Eqn. 24, the number of requests in effect already accepted by the input ports (really the 2 groups of input ports) in the normalisation phase is

$${[ {\sum }_{j}^{} {Q}_{norm} ( n , j ) ]}_{agg} = [ \begin{matrix}6 \\ 6\end{matrix} ] \qquad Eqn . 31$$

Because each sub-element group contains 2 overall input ports, the remaining number, of acceptances available in each sub-element group is therefore

$$[ \begin{matrix}2 F \\ 2 F\end{matrix} ] - {[ {\sum }_{j}^{} {Q}_{norm} ( n , j ) ]}_{agg} = [ \begin{matrix}8 \\ 8\end{matrix} ] - [ \begin{matrix}6 \\ 6\end{matrix} ] = [ \begin{matrix}2 \\ 2\end{matrix} ] \qquad Eqn . 32$$

The matrix to be used in this input booking phase is the additional output booking grants matrix [g₁(n,j)] (Eqn. 30). Step 2 of the “no overbooking” algorithm applies. All of the additional grants are therefore accepted, so the additional acceptance matrix is

$$additional input booking acceptances , \\ [ {a}_{1 additional} ( n , j ) ] = [ \begin{matrix}0 & 1 & 0 & 1 \\ 1 & 0 & 1 & 0\end{matrix} ] \qquad Eqn . 33$$

The final 1^{st}-level acceptance matrix becomes

$$\begin{matrix}[ {a}_{1} ( n , j ) ] = {[ {Q}_{norm} ( n , j ) ]}_{agg} + [ {a}_{1 additional} ( n , j ) ] \\ = [ \begin{matrix}0 & 1 & 3 & 2 \\ 3 & 2 & 0 & 1\end{matrix} ] + [ \begin{matrix}0 & 1 & 0 & 1 \\ 1 & 0 & 1 & 0\end{matrix} ] \\ = [ \begin{matrix}0 & 2 & 3 & 3 \\ 4 & 2 & 1 & 1\end{matrix} ]\end{matrix} \qquad Eqn . 34$$

Note that all output ports fill all F=4 time slots and all input ports (sub-element groups) fill all 2F=8 time slots, in this first frame. A full set of 16 cells or packets are accepted.

Multi-Level Matching—The Second Level Matching for Sub-element Group 1

From Eqn. 23 the queue matrix for the first sub-element group (i.e. the aggregation of input ports comprising the first element) is

$${[ Q ( i , j ) ]}_{individual} = [ \begin{matrix}1 & 2 & 4 & 8 \\ 2 & 4 & 8 & 1\end{matrix} ] \qquad Eqn . 35$$

and from Eqn 34 the number of acceptances to each output port from the 1^{st} level of matching for this aggregation are
[a₁(1,j)]=[0 2 3 3] Eqn. 36

These acceptances represent the maximum number of grants that will be allowed by each output port to all input ports in this 2^{nd} level of matching.

Multi-Level Matching—The Second Level Matching for Sub-Element Group 1 Normalisation Stage

The maximum row-sum or column-sum, maxval, in Eqn. 35 is 15. The normalised queue matrix [Qₙₒᵣₘ(i,j)]_{individual} is obtained from Eqn. 35 by multiplying each element by the factor F/maxval=4/15 and taking the integer part of the resulting number, i.e.

$${[ {Q}_{norm} ( i , j ) ]}_{individual} = [ \begin{matrix}0 & 0 & 1 & 2 \\ 0 & 1 & 2 & 0\end{matrix} ] \qquad Eqn . 37$$

All of these cells or packets are assumed already to be granted by the output ports and accepted by the input ports. The request matrix presented to the next “no overbooking” stage is the difference between the original queue matrix and the normalised queue matrix, i.e. the remaining requests

$$\begin{matrix}[ {r}_{2} ( i , j ) ] = {[ Q ( i , j ) ]}_{individual} - {[ {Q}_{norm} ( i , j ) ]}_{individual} \\ = [ \begin{matrix}1 & 2 & 4 & 8 \\ 2 & 4 & 8 & 1\end{matrix} ] - [ \begin{matrix}0 & 0 & 1 & 2 \\ 0 & 1 & 2 & 0\end{matrix} ] \\ = [ \begin{matrix}1 & 2 & 3 & 6 \\ 2 & 3 & 6 & 1\end{matrix} ]\end{matrix} \qquad Eqn . 38$$

Multi-Level Matching—The Second Level Matching for Sub-Element Group 1 “No Overbooking” Stage—Output Booking Phase

The number of requests in effect already granted by the output ports in the normalisation stage is

$${[ {\sum }_{i}^{} {Q}_{norm} ( i , j ) ]}_{individual} = [ \begin{matrix}0 & 1 & 3 & 2\end{matrix} ] \qquad Eqn . 39$$

The number of additional grants allowed is

$$\begin{matrix}[ {a}_{1} ( 1 , j ) ] - {[ {\sum }_{i}^{} {Q}_{norm} ( i , j ) ]}_{individual} = [ \begin{matrix}0 & 2 & 3 & 3\end{matrix} ] - [ \begin{matrix}0 & 1 & 3 & 2\end{matrix} ] \\ = [ \begin{matrix}0 & 1 & 0 & 1\end{matrix} ]\end{matrix} \qquad Eqn . 40$$

Step 3 of the “no overbooking” algorithm applies. The pointer positions in the first cycle or frame (k=0) are as in FIG. 8. Output port 2 points to input port 1 and output port 4 also points to input port 1. Both additional grants are made, i.e.

$$additional output booking grants , \\ [ {g}_{2} ( i , j ) ] = [ \begin{matrix}0 & 1 & 0 & 1 \\ 0 & 0 & 0 & 0\end{matrix} ] \qquad Eqn . 41$$

Multi-Level Matching—The Second Level Matching for Sub-Element Group 1 “No Overbooking” Stage—Input Booking Phase

The number of requests in effect already accepted by the input ports in the normalisation stage is

$${[ {\sum }_{j}^{} {Q}_{norm} ( i , j ) ]}_{individual} = [ \begin{matrix}3 \\ 3\end{matrix} ] \qquad Eqn . 42$$

The number of additional acceptances allowed is

$$[ \begin{matrix}F \\ F\end{matrix} ] - {[ {\sum }_{j}^{} {Q}_{norm} ( i , j ) ]}_{individual} = [ \begin{matrix}4 \\ 4\end{matrix} ] - [ \begin{matrix}3 \\ 3\end{matrix} ] = [ \begin{matrix}1 \\ 1\end{matrix} ] \qquad Eqn . 43$$

The request matrix for this input booking phase is the additional output booking grants matrix [g₂(i,j)] (Eqn. 41). Step 3 of the “no overbooking” algorithm applies. In the first cycle or frame input port 1 points to output port 4 (FIG. 8), so the additional input booking acceptance matrix becomes

$$[ {a}_{2 additional} ( i , j ) ] = [ \begin{matrix}0 & 0 & 0 & 1 \\ 0 & 0 & 0 & 0\end{matrix} ] \qquad Eqn . 44$$

The final acceptance matrix is the sum of the acceptances from the initial normalisation (Eqn. 37) plus these additional acceptances from the “no overbooking” algorithm (Eqn. 44), i.e.

$$\begin{matrix}{[ {a}_{2} ( i , j ) ]}_{i = 1 , 2} = {[ {Q}_{norm} ( i , j ) ]}_{individual} + [ {a}_{2 additional} ( i , j ) ] \\ = [ \begin{matrix}0 & 0 & 1 & 2 \\ 0 & 1 & 2 & 0\end{matrix} ] + [ \begin{matrix}0 & 0 & 0 & 1 \\ 0 & 0 & 0 & 0\end{matrix} ] \\ = [ \begin{matrix}0 & 0 & 1 & 3 \\ 0 & 1 & 2 & 0\end{matrix} ]\end{matrix} \qquad Eqn . 45$$

Multi-Level Matching—The Second Level Matching for Sub-Element Group 2

From Eqn. 23 the queue matrix for the second sub-element group (i.e. the second group of sub-elements) is

$${[ Q ( i , j ) ]}_{individual} = [ \begin{matrix}4 & 8 & 1 & 2 \\ 8 & 1 & 2 & 4\end{matrix} ] \qquad Eqn . 46$$

and from Eqn. 34 the number of acceptances to each output port from the 1^{st} level of matching are
[a₁(2,j)]=[4 2 1 1] Eqn. 47

These acceptances represent the maximum number of grants that will be allowed by each output port to all input ports in this 2^{nd} level of matching.

Multi-Level Matching—The Second Level Matching for Sub-Element Group 2 Normalisation Stage

The maximum row-sum or column-sum, maxval, in Eqn. 46 is 15. The normalised queue matrix [Qₙₒᵣₘ(i,j)]_{individual} is obtained from Eqn. 46 by multiplying each element by the factor F/maxval=4/15 and taking the integer part of the resulting number, i.e.

$${[ {Q}_{norm} ( i , j ) ]}_{individual} = [ \begin{matrix}1 & 2 & 0 & 0 \\ 2 & 0 & 0 & 1\end{matrix} ] \qquad Eqn . 48$$

All of these cells or packets are assumed already to be granted by the output ports and accepted by the input ports. The request matrix presented to the next “no overbooking” stage is the difference between the original queue matrix and the normalised queue matrix, i.e. the remaining requests

$$\begin{matrix}[ {r}_{2} ( i , j ) ] = {[ Q ( i , j ) ]}_{individual} - {[ {Q}_{norm} ( i , j ) ]}_{individual} \\ = [ \begin{matrix}4 & 8 & 1 & 2 \\ 8 & 1 & 2 & 4\end{matrix} ] - [ \begin{matrix}1 & 2 & 0 & 0 \\ 2 & 0 & 0 & 1\end{matrix} ] \\ = [ \begin{matrix}3 & 6 & 1 & 2 \\ 6 & 1 & 2 & 3\end{matrix} ]\end{matrix} \qquad Eqn . 49$$

Multi-Level Matching—The Second Level Matching for Sub-Element Group 2 “No Overbooking” Stage—Output Booking Phase

The number of requests in effect already granted by the output ports in the normalisation stage is

$${[ {\sum }_{i}^{} {Q}_{norm} ( i , j ) ]}_{individual} = [ \begin{matrix}3 & 2 & 0 & 1\end{matrix} ] \qquad Eqn . 50$$

The number of additional grants allowed is

$$\begin{matrix}[ {a}_{1} ( 2 , j ) ] - {[ {\sum }_{i}^{} {Q}_{norm} ( i , j ) ]}_{individual} = \begin{matrix}[ \begin{matrix}4 & 2 & 1 & 1\end{matrix} ] - \\ [ \begin{matrix}3 & 2 & 0 & 1\end{matrix} ]\end{matrix} \\ = [ \begin{matrix}1 & 0 & 1 & 0\end{matrix} ]\end{matrix} \qquad Eqn . 51$$

Step 3 of the “no overbooking” algorithm applies. The pointer positions in the first cycle or frame are as in FIG. 8. Output port 1 points to input port 2 and output port 3 also points to input port 2. Both additional grants are made, i.e.

$$additional output booking grants , [ {g}_{2} ( i , j ) ] = [ \begin{matrix}0 & 0 & 0 & 0 \\ 1 & 0 & 1 & 0\end{matrix} ] \qquad Eqn . 52$$

Multi-Level Matching—The Second Level Matching for Sub-Element Group 2 “No Overbooking” Stage—Input Booking Phase

The number of requests in effect already accepted by the input ports in the normalisation stage is

$${[ {\sum }_{j} {Q}_{norm} ( i , j ) ]}_{individual} = [ \begin{matrix}3 \\ 3\end{matrix} ] \qquad Eqn . 53$$

The number of additional acceptances allowed is

$$[ \begin{matrix}F \\ F\end{matrix} ] - {[ {\sum }_{j} {Q}_{norm} ( i , j ) ]}_{individual} = [ \begin{matrix}4 \\ 4\end{matrix} ] - [ \begin{matrix}3 \\ 3\end{matrix} ] = [ \begin{matrix}1 \\ 1\end{matrix} ] \qquad Eqn . 54$$

The request matrix for this input booking phase is the additional output booking grants matrix [g₂(i,j)] (Eqn. 52). Step 3 of the “no overbooking” algorithm applies. In the first cycle or frame input port 2 points to output port 3 (FIG. 8), so the additional input booking acceptance matrix becomes

$$[ {a}_{2 additional} ( i , j ) ] = [ \begin{matrix}0 & 0 & 0 & 0 \\ 0 & 0 & 1 & 0\end{matrix} ] \qquad Eqn . 55$$

The final acceptance matrix is the sum of the acceptances from the initial normalisation (Eqn. 48) plus these additional acceptances from the “no overbooking” algorithm (Eqn. 55), i.e.

$$\begin{matrix}{[ {a}_{2} ( i , j ) ]}_{i = 3 , 4} = {[ {Q}_{norm} ( i , j ) ]}_{individual} + [ {a}_{2 additional} ( i , j ) ] \\ = [ \begin{matrix}1 & 2 & 0 & 0 \\ 2 & 0 & 0 & 1\end{matrix} ] + [ \begin{matrix}0 & 0 & 0 & 0 \\ 0 & 0 & 1 & 0\end{matrix} ] \\ = [ \begin{matrix}1 & 2 & 0 & 0 \\ 2 & 0 & 1 & 1\end{matrix} ]\end{matrix} \qquad Eqn . 56$$

Multi-Level Matching—Overall Acceptance Matrix

The overall matrix of accepted requests is the concatenation of Eqn. 45 and Eqn. 56 for the two sub-element groups, i.e.

$$[ {a}_{2} ( i , j ) ] = [ \begin{matrix}0 & 0 & 1 & 3 \\ 0 & 1 & 2 & 0 \\ 1 & 2 & 0 & 0 \\ 2 & 0 & 1 & 1\end{matrix} ] \qquad Eqn . 57$$

Note that the 2^{nd} level of matching has been unable to maintain the full set of 16 acceptances achieved by the 1^{st} level of matching of the sub-element groups. Only 14 cell or packet requests are finally accepted. This contrasts with the acceptance matrix resulting from conventional, single-level matching in Eqn. 22, which achieves a full set of 16 acceptances. The reason for the reduction in accepted requests may be due to the nature of the modified NOB25 pointer up-date rule suggested for use with asymmetric request matrices in Eqn. 28. This is discussed below, and a further modification is proposed.

Multi-Level Matching—Pointer Up-Date Rules for Asymmetric Request Matrices

For the particular asymmetric request matrices used in the working example, there appears to be a problem with the modified NOB25-like pointer up-date rule (Eqn. 28). It can be shown that there are pairs of output ports that always point to just one, common, input port in every frame. (The particular input port for a given pair of output ports changes cyclically from frame to frame). This can result in requests being granted by two output ports to the same input port during the output booking phase, causing overbooking, which causes one of these grants to be dropped during the following input booking phase. This never happens for symmetric request matrices, because output port pointers never point to the same input port; there are enough input ports for all the output port pointers to point to different input ports. The problem has been found to happen when only two of the output ports are able to grant additional requests, and the two ports happen to be a pair that point to the same input port.

One embodiment of the invention provides a possible solution to this problem by deciding the pointer positions after the number m of output ports that are allowed to make additional grants is known. This would no longer be a deterministic pointer up-date rule. However, the nature of the no overbooking algorithm described above (“NOB25”) could be preserved to some extent by adapting the rule to the variable number of output ports m. Once this number m is known for a matching in a frame, these m ports would be ranked in order and the output port pointer positions would be calculated as follows
for output ports: pᵢₙ=1+[(m−Pₒᵤₜ+k)_{mod L}] Eqn. 58
where Pₒᵤₜ is now the rank of the output port allowed to make additional grants, not the output port's identity. If the same sub-set of output ports are allowed to make additional grants recurrently in each frame, then the overall effect may be like NOB25, in that the pointers would step around these ports by one port in each frame. In the worked example, if the same two output ports were to recur in every frame, they would always point to different input ports, which should remove the output overbooking.

Because there are always more output ports than input ports in the asymmetric request matrices, so that no two input ports ever need to point to the same output port, there is no need to adapt the NOB25 rule for the input ports. For these ports the pointer up-date rule can remain deterministic. The input port pointer positions would be calculated as in Eqn. 28, i.e.
for input ports: pₒᵤₜ=1+[(LN−Pᵢₙ+k)_{mod LN}] Eqn. 59
where Pᵢₙ is the input port's identity.

Using this rule, it can be shown that the overall acceptance matrix for the worked example using multi-level matching becomes

$$[ {a}_{2} ( i , j ) ] = [ \begin{matrix}0 & 0 & 1 & 3 \\ 0 & 2 & 2 & 0 \\ 1 & 2 & 1 & 0 \\ 3 & 0 & 0 & 1\end{matrix} ] \qquad Eqn . 60$$

The matching now accepts a full set of 16 requests in the first frame. They are not all taken from the longest VOQs. For example, a₂(3,3) is one of the shortest queues with only one request.

Those skilled in the art will appreciate that the number of hierarchical matching levels depends on the number of levels of aggregation used: In the examples discussed with reference to FIGS. 3 to 8 of the accompanying drawings, only two levels of aggregation were used. For larger switch arrangements it is possible to have more than two levels of aggregation and the number of matching levels increases accordingly.

The invention can be applied to switching arrangements having bi-directional elements/sub-elements as is apparent to those skilled in the art. The invention can be implemented in any suitable form, including as a suite of one or more computer programs which may be implemented using software and/or hardware and the matching algorithm may be provided in a form which is distributed amongst several components.

The matching process can thus be implemented by one or more hardware and/or software components arranged to provide suitable means. For example, to implement the matching process on requests for service which are queued at the input of the input queued switch, the hardware and/or software component implementing the invention may include arbiters of parallel or serial operation.

Those skilled in the art will also realise that where reference has been made to the switch arrangement having NL inputs and NL outputs, this can be generalised to the case where a switch arrangement has NL₁ inputs and ML₂ outputs, and that specific features of such embodiments are not limited to the specified number of inputs and outputs which have been described here for simplicity.

In the embodiment of the invention described above, the multi-level matching technique first matches N input elements to ML₂ output sub-elements, at the highest level of the matching hierarchy, then matches the L₁ input sub-elements within each input element to the ML₂ output sub-elements. As will be apparent to those skilled in the art, more than two hierarchical levels can be implemented by this invention, but the embodiment described above employs a two level hierarchy for simplicity. This can provide a better matching for request matrices than is possible using other scheduling algorithms that perform the matching with a greater degree of aggregation of output ports, nodes or terminals, such as ring-to-ring or PON-to-PON.

Those skilled in the art will recognise that in the context of the invention, the term element refers collectively to a group of sub-elements. The above embodiments of the invention have described various examples where firstly all the input elements of the switch arrangement are matched to the output sub-elements of the switch arrangement (i.e., groups of sub-elements are matched to output sub-elements of the switch arrangement) and then the individual sub-elements in each group are matched to the output sub-elements of the switch arrangement. However, it is possible to group the sub-elements of the outputs, and outlet grouping can be combined with input grouping.

Outlet Grouping

It is known to have switch (and network) arrangements where groups of output ports all have the same destination, e.g. where they all transmit on the same link to the next switch. It is known from ATM switching that under these circumstances it does not matter to which particular output port of such a group of output ports the individual cells are sent by the ATM switch fabric. This is known as outlet grouping, and it reduces the blocking probability of output contention, by sharing the group of output ports between all cells destined for the same outgoing link. This approach is also known to be attractive in optical packet networks, where a number of wavelength channels within the same outgoing fibre link are shared between the cells or packets within the fibre. It does not matter which wavelength channel is used by each individual cell or packet. Not only is blocking resulting from output contention reduced by outlet grouping, but the computing complexity of matching and channel assignment (both time-slot and wavelength) may also be reduced, due to the aggregation of output ports (output sub-elements) into groups of output ports (output elements).

Although there are potential problems of cell or packet mis-sequencing at subsequent switches, which may need to be addressed, such outlet grouping can be dealt with very easily within the framework of multi-level matching. In this embodiment applied to outlet grouping, consider L₂ output sub-elements within an output element constituting an outlet group, of which there are M. Matching is still performed in multiple levels. For example, with just two levels of matching, the first (highest) level would be between input elements and output elements and the second level of matching would be between input sub-elements and output elements. Since both levels match to output elements rather than sub-elements, the number of cell or packet requests that can be accepted to each output element is obviously L₂ times greater than to each individual output sub-element.

Accordingly, process for resolving contention when scheduling traffic across an input-queued switch arrangement is provided by the invention. The process is also capable of resolving service contention across a circuit switch arrangement. The process involves a method to match service requests between a number of input sub-elements and a number of output sub-elements. The input sub-elements are aggregated into groups whose service requests are then matched to either the output sub-elements or to aggregations of the output sub-elements. The individual input sub-elements of each aggregation of input sub-elements are then matched to the output sub-elements or to the aggregation of output sub-elements. This provides a hierarchical, two-level matching process. More generally, a matching process is provided for a number N of first elements, each first element arranged to at least provide ingress to a switch arrangement, each of the first N elements comprising a number L₁ of first sub-elements, the switch arrangement having a number ML₂ of second sub-elements arranged to at least provide egress from said switch arrangement, and wherein each of the first L₁ sub-elements is capable of conveying a service request for at least one of said second sub-elements ML₂, wherein the process comprises: firstly, for every one of the N first elements, aggregating service requests from all L₁ first sub-elements to each of the ML₂ second sub-elements or to each of the M aggregations of L₂ second sub-elements, and secondly, resolving contention for said service requests from all N first elements to one or more of said second ML₂ sub-elements or of said M aggregations of L₂ second sub-elements, and thirdly, for each first element, resolving contention between the L₁ sub-elements and said second ML₂ sub-elements or said M aggregations of L₂ second sub-elements. The matching process can be extended to any number of hierarchical levels by considering elements in one hierarchical level as sub-elements in a higher level. Matching is performed first at the highest level of the hierarchy, then in turn down through the matching levels to the lowest matching level of the hierarchy.

1-52. (canceled)

53. A matching method for a switch arrangement comprising number N of first elements, each first element arranged to at least provide ingress to the switch arrangement, each of the first N elements comprising a number L₁ of first sub-elements, the switch arrangement having a number ML₂ of second sub-elements arranged to at least provide egress from said switch arrangement, and wherein each of the first L₁ sub-elements is capable of conveying a service request for at least one of said second sub-elements ML₂, wherein the ML₂ sub-elements are grouped into M aggregations of L₂ sub-elements, and the method comprises:
firstly, for every one of the N first elements, aggregating service requests from all L₁ first sub-elements to each of the M aggregations of L₂ second sub-elements, and
secondly, resolving contention for said service requests from all N first elements to one or more of said M aggregations pf L₂ second sub-elements, and
thirdly, for each first element, resolving contention between the L₁ sub-elements and said M aggregations of L₂ second sub-elements.

54. A matching method as claimed in claim 53, wherein the matching method comprises the following steps:
performing a first matching across the switch fabric for each of the plurality of N input elements and the ML₂ sub-elements by performing the steps of:
summing a number of requests from each of the L₁ sub-elements of the input element;
generating a first N×ML₂ request matrix;
matching the first request matrix to generate a first matrix of accepted requests; and
performing a second matching across the switch fabric for each of the N input elements by performing the steps of:
generating N asymmetric second L₁×ML₂ matrices, one for each of the N input elements; and
matching each of the N asymmetric second matrices to generate N second matrices of accepted requests; and
generating a NL₁×ML₂ matrix of accepted requests from the first N×ML₂ matrix of accepted requests and the N second L₁×ML₂ accepted request matrices.

55. A matching method as claimed in claim 54, wherein the NL₁×ML₂ matrix of requests is symmetric.

56. A matching method as claimed in claim 54, wherein L₁ is equal to L₂ and N is equal to M.

57. A matching method as claimed in 54, wherein a said sub-element comprise one of the following:
a port of a switch;
a port of a switching network;
a wavelength channel in an optical network;
a node in an optical ring network;
a terminal in an un-amplified passive optical network;
a terminal in an amplified passive optical network.

58. A matching method as claimed in claim 54, wherein the sub-elements comprise ports, and the matching method updates the pointers to input ports according to the following rule:
pₒᵤₜ=1+[(LN−Pᵢₙ+k)_{mod LN}] and
the output ports are updated according to the following rule:
pᵢₙ=1+[(LN−Pₒᵤₜ+k)_{mod L}].

59. A matching method as claimed in claim 54, wherein the sub-elements comprise ports, and the matching method updates the pointers to input ports according to the following rule:
pₒᵤₜ=1+[(LN−Pᵢₙ+k)_{modLN}] and
the output ports are updated according to the following rule:
pᵢₙ=1+[(m−(m−Pₒᵤₜ+K)_{modL}]

60. A matching method as claimed in claim 53, wherein the ML₂ output sub-elements are grouped first into M groups pf L₂ sub-elements, and matching is performed first at the group level between the N groups of L₁ input sub-elements and the M groups of L₂ output sub-elements, and then, for each of the N groups of L₁ input sub-elements, between the L₁ individual input sub-elements and the M groups of L₂ output sub-elements.

61. A method as claimed in claim 53, wherein said first sub-elements and said second sub-elements are bi-directional.

62. A matching method as claimed in claim 53, wherein the step of resolving contention between the L₁ sub-elements and said second ML₂ sub-elements is performed in parallel for each said first element.

63. A matching method as claimed in claim 60, wherein said first and second sub-elements comprise ports in the switch arrangement, said first elements comprise aggregations of said first sub-elements and said second elements comprise aggregations of said second sub-elements.

64. A matching method as claimed in claim 53, wherein said switch arrangement comprises an input queued cell switch arrangement and said service requests comprise requests for transmitting a service information rate from one of said first sub-elements to at least one of said second sub-elements.

65. A matching method as claimed in claim 53, wherein said switch arrangement comprises an input queued cell switch and said service requests comprise requests for transmitting at least one cell from one of said first sub-elements to at least one of said second sub-elements.

66. A method as claimed in claim 53, wherein said switch arrangement comprises a circuit based switch and said service request comprises a request for at least one of the following:
a connection in the circuit-based switch;
a wavelength channel in the circuit-base J switch
a bandwidth in the circuit-based switch;
a service information rate in the circuit-based switch;
a bit rate in the circuit-based switch.

67. A method as claimed in claim 53, wherein the switch arrangement comprises a network, and wherein said elements comprise aggregations of network terminals or nodes and said sub-elements comprise network terminals or nodes.

68. A method as claimed in claim 53, wherein the switch arrangement comprises an arrangement of inter-connectable sub-networks, where said elements comprise sub-networks and said sub-elements comprise network terminals or nodes.

69. A method as claimed in claim 53, wherein the method of matching comprises:
firstly, aggregating service requests to a highest level of a matching hierarchy, and
secondly, resolving contention for said service requests at the highest level of the matching hierarchy, and
thirdly, resolving contention in turn down through the matching levels to the lowest level of matching.

70. A matching method for a multi-stage switch arrangement having a plurality of logically associated inputs and a plurality of outputs, wherein the matching method comprises the steps of:
for each logical association of inputs, aggregating service requests from every one of the inputs which form said logical association;
resolving contention for said aggregated service requests between all of the logical associations to the outputs of the switch arrangement; and
repeating the above steps in the matching method within each logical association for a subset of the inputs forming each said logical association until contention is resolved between the individual inputs of the switch arrangement and the outputs of the switch arrangement.

71. A matching method as claimed in claim 70, wherein in each repetition, the number of inputs forming the logical association is reduced until each logical association of a sub-set comprises a single input to the switch arrangement, said aggregated service requests comprise a single service request, whereby contention is resolved between each input of the switch arrangement and each output of the switch arrangement.

72. A method as claimed in claim 70, wherein each step resolving contention between the outputs of the switch arrangement comprises resolving contention between a logical association of inputs and a logical association of outputs having the same number of inputs.

73. A matching method as claimed in claim 70, wherein said multi-stage switch arrangement comprises a plurality of switching stages, at least one switching stage comprising:
a plurality of switches which logically associated into different sets of switches, each set of switches being logically associated With one of said logical associations of inputs of the switch arrangement, wherein each set of logically associated switches operate only on the inputs of the switch arrangement with which they are logically associated, the switch arrangement further comprising a global spatial switching stage arranged to receive traffic derived from any of the inputs of the switch arrangement via any logically adjacent sets of said switches.

74. A matching method as claimed in claim 70, wherein said multi-stage switch arrangement comprises a plurality of switching stages, at least one switching stage comprising:
a plurality of switches which logically associated into different sets of switches, each set of switches being logically associated with one of said logical associations of outputs of the switch arrangement, wherein each set of logically associated switches operate only to provide output to the outputs of the switch arrangement with which they are logically associated.

75. A multi-stage switch arrangement arranged to switch time-slotted traffic segments, the switch arrangement comprising:
a plurality of switching stages including spatial switching stage arranged to receive traffic which has been switched by at least one switching stage logically adjacent to the input of spatial switching stage, the spatial switching stage being further arranged to output to at least one switching stage logically adjacent to its output,
each of said at least one switching stage logically adjacent to the input of the spatial switching stage comprises a plurality of input aggregation switching stages, each aggregation switching stage being logically associated with a subset of the inputs of the switch arrangement,
each of said at least one switching stage logically adjacent to the output of the spatial switching stage comprises a plurality of output aggregation switching stages,
each output aggregation switching stage being logically associated with a subset of the outputs of the switch arrangement,
the multi-stage switch being further arranged to implement suitable control means to enable the time-slotted traffic to be matched according to the matching method as claimed in claim 70.

76. A switch arrangement, the switch arrangement having number N of first elements, each first element arranged to at least provide ingress to a switch arrangement, each of the first N elements comprising a number L₁ of first sub-elements, the switch arrangement having a number ML₂ of second sub-elements arranged to at least provide egress from said switch arrangement, and wherein each of the first L₁ sub-elements is capable of conveying a service request for at least one of said second sub-elements ML₂, wherein said service requests are conveyed by performing a matching method which comprises:
for each of the N first elements, aggregating service requests from all L₁ first sub-elements to each of the ML₂ second sub-elements, and
resolving contention for said service requests from all N first elements to one or more of said second ML₂ sub-elements, and
for each of the N first elements, resolving contention between the L₁ sub-elements and said second ML₂ sub-elements.

77. A network including a switch arrangement as claimed in claim 70.

78. A suite of at least one computer programs arranged when executed to implement steps in a method according to claim 53.

79. A suite of at least one computer programs as claimed in claim 78, wherein at least one program is arranged to be implemented by software running on a suitable computational device.

80. A scheduler for a switching arrangement, the scheduler arranged to perform a scheduling process, the scheduling process comprising:
a matching method as claimed in claim 53; and a channel assignment process.
